(19) United States
(12) Patent Application Publication
(10) Pub. No.: US 2026/0367560 A1
(43) Pub. Date: Nov. 19, 2026

(54) IMAGE FORMING APPARATUS, METHOD FOR CONTROLLING IMAGE FORMING APPARATUS, AND PROGRAM

(71) Applicant: CANON KABUSHIKI KAISHA, Tokyo (JP)

(72) Inventor: JUN ITOH, Chiba (JP)

(21) Appl. No.: 19/670,742

(22) Filed: May 7, 2026

(30) Foreign Application Priority Data
May 13, 2025 (JP) 2025-080630

(51) Int. Cl. G03G 15/00

(52) U.S. Cl. CPC G03G 15/5058; G03G 15/5025; G03G 2215/00059; G03G 2215/00067

(57) ABSTRACT

An image forming apparatus includes a transfer unit configured to transfer an image onto a sheet, a detection unit configured to detect information related to temperature, a calibration determination unit configured to determine, based on the temperature detected by the detection unit, whether calibration using an image formed by the transfer unit is executable, and a control unit configured, when the calibration determination unit determines that the calibration is executable, to notify a user that the calibration is to be performed and to control execution of the calibration.

### BACKGROUND

### Field of the Technology

The present disclosure relates to an image forming apparatus, a method for controlling the image forming apparatus, and a program.

### Description of the Related Art

In an image forming apparatus, density and gradation characteristics of an output image may differ from desired density and gradation characteristics due to influences such as short-term variations caused by changes in an environment in which the apparatus is installed or changes in an environment inside the apparatus, and long-term variations caused by aging (deterioration over time) of a photosensitive member or a developer. Accordingly, in order to adjust the density and gradation characteristics of an output image to desired density and gradation characteristics, it is necessary for an image forming apparatus to correct image forming conditions as appropriate in consideration of various variations. A process for appropriately correcting changes in density and color tone is generally referred to as calibration. A calibration method is known in which a pattern image is formed on a sheet, a photosensitive member, or an intermediate transfer member, gradation pattern information is read by an image reading unit, and the gradation pattern information is fed back to image forming conditions such as γ correction.

When a pattern image is formed on an intermediate transfer member, it is necessary to remove the formed pattern image from the intermediate transfer member after the pattern image is read and gradation pattern information is fed back to image forming conditions.

To remove the pattern image, a cleaning blade is used. The pattern image is removed by bringing the cleaning blade into sliding contact with the intermediate transfer member. The details of the cleaning blade member and a method for manufacturing the cleaning blade are described in, for example, Japanese Patent Laid-Open No. 2015-206990.

In a low-temperature environment, a pattern image formed on an intermediate transfer member cannot be sufficiently removed. If color misregistration correction is performed in such a situation, the pattern image remaining on the intermediate transfer member is transferred to a sheet. For example, since the cleaning blade is made of a member such as urethane rubber, elasticity of the member decreases under a low-temperature condition, and thus the pattern image formed on the intermediate transfer member may not be sufficiently removed.

### SUMMARY

According to an aspect of the present disclosure, there is provided an image forming apparatus including a transfer unit configured to transfer an image onto a sheet, a detection unit configured to detect information related to temperature, a calibration determination unit configured to determine, based on the temperature detected by the detection unit, whether calibration using an image formed by the transfer unit is executable, and a control unit configured, when the calibration determination unit determines that the calibration is executable, to notify a user that the calibration is to be performed and to control execution of the calibration.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic overall configuration diagram of an image forming apparatus according to an embodiment.

FIG. 2 is a cross-sectional view of the image forming apparatus according to an embodiment.

FIG. 3 is a cross-sectional view of a scanner according to an embodiment.

FIG. 4 is a sequence diagram illustrating a series of processes performed in a normal operation according to a first embodiment.

FIG. 5 is a sequence diagram illustrating a series of processes performed when correction is prohibited in the first embodiment.

FIG. 6 is a diagram illustrating examples of screens displayed on an operation panel according to the first embodiment.

FIG. 7 is a flowchart of correction processing according to the first embodiment.

FIG. 8 is a sequence diagram illustrating a series of processes performed in a normal operation according to a second embodiment.

FIG. 9 is a sequence diagram illustrating a series of processes performed when correction is prohibited in the second embodiment.

FIG. 10 is a diagram illustrating examples of screens displayed on an operation panel according to the second embodiment.

FIG. 11 is a flowchart of correction processing according to the second embodiment.

FIG. 12 is a sequence diagram illustrating a series of processes performed in a normal operation according to a third embodiment.

FIG. 13 is a sequence diagram illustrating a series of processes performed when correction is prohibited in the third embodiment.

FIG. 14 is a diagram illustrating examples of screens displayed on an operation panel according to the third embodiment.

FIG. 15 is a flowchart of correction processing according to the third embodiment.

FIG. 16 is a sequence diagram illustrating a series of processes performed in a normal operation according to a fourth embodiment.

FIG. 17 is a sequence diagram illustrating a series of processes performed in a low-temperature state according to the fourth embodiment.

FIG. 18 is a flowchart of correction processing according to the fourth embodiment.

FIG. 19 is a sequence diagram according to a fifth embodiment.

FIG. 20 is a flowchart of correction processing according to the fifth embodiment.

FIG. 21 is a sequence diagram according to a sixth embodiment.

FIG. 22 is a flowchart of correction processing according to the sixth embodiment.

### DESCRIPTION OF THE EMBODIMENTS

Embodiments of the present disclosure will be described in detail hereinbelow with reference to the accompanying drawings. Although the embodiments will be described in connection with an electrophotographic system, the features of the control, in particular, the matters described in the claims, are also applicable to ink-jet printers, dye-sublimation printers, and the like, which have the same issues, and the issues can be solved by using the method described below. Accordingly, it is asserted that the above claims are within the scope of the claims even when applied to each image forming apparatus. Each of the embodiments of the present invention described below can be implemented solely or as a combination of a plurality of the embodiments or features thereof where necessary or where the combination of elements or features from individual embodiments in a single embodiment is beneficial.

### First Embodiment

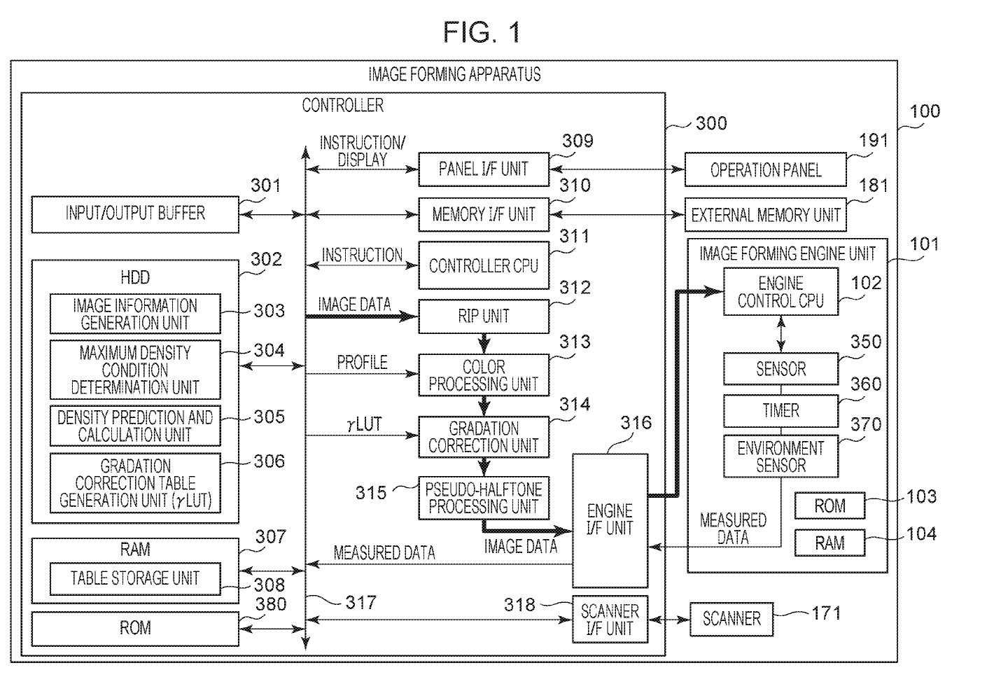

FIG. 1 is a diagram illustrating a system configuration according to an embodiment of the present disclosure.

In an image forming apparatus 100, a controller 300 includes a controller central processing unit (CPU) 311 that controls overall operation of the image forming apparatus 100. A read-only memory (ROM) 380 stores a system boot program. A hard disk drive (HDD) 302 stores a control program and control data for the controller CPU 311. A random-access memory (RAM) 307 is used as a work memory for interpreting the above control code and data, performing calculations necessary for printing, and processing print data. An image information generation unit 303 generates various image objects based on settings of print data received from an external computer. A raster image processor (RIP) unit 312 rasterizes the image objects into bitmap images. A color processing unit 313 performs multi-color conversion processing. A gradation correction unit 314 performs gradation correction for a single color. A pseudo-halftone processing unit 315 performs pseudo-halftone processing such as dithering using a dither matrix or an error diffusion method. An engine interface (I/F) unit 316 transfers the converted image to an image forming engine unit 101, where the image is formed. The above is a flow of image processing performed by the controller 300 during basic print image formation, and is indicated by thick solid lines. The print processing is not limited to a case where an image obtained by the RIP unit 312 is used. Printing can be performed by performing image processing (312, 313, and 314) using an image read by a scanner 171 in copying, and using an image generated on the RAM 307 by the controller CPU 311 in printing of a calibration chart.

The controller 300 is also responsible for various control calculations in addition to controlling the above image formation. The controller 300 stores, in the ROM 380, a control program for such processing, and includes a maximum density condition determination unit 304 configured to perform maximum density adjustment, a density prediction and calculation unit 305 configured to predicting density based on, for example, an output value from a sensor, and a gradation correction table generation unit (γLUT) 306 configured to perform density and gradation correction. The gradation correction table (γLUT) is a set of correction value parameters that assign output values to input values, and is obtained by assigning corresponding output values to all possible luminance values or density values of an image as input values. By using the gradation correction table (γLUT), gradation correction according to the characteristics of the image forming engine unit 101 can be achieved.

The image forming apparatus 100 further includes a table storage unit 308 configured to temporarily store adjustment results obtained by the maximum density condition determination unit 304 through the gradation correction table generation unit 306, an operation panel 191 configured to receive an instruction to operate a printing apparatus and an instruction to perform the above correction processing, a panel I/F unit 309 configured to connect the controller 300 and the operation panel 191, an external memory 181 configured to store print data and various information regarding the printing apparatus, a memory I/F unit 310 configured to connect the controller 300 and the external memory 181, and a system bus 317 configured to connect the units.

The controller 300 is configured to instruct a scanner 171 to read a document via a scanner I/F unit 318 and to store image data read by the scanner 171 in the RAM 307.

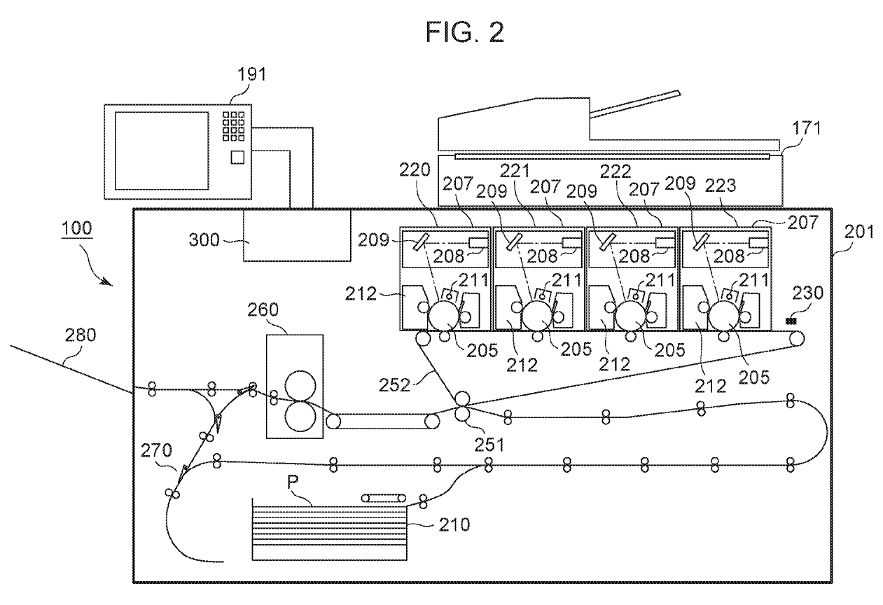

The image forming engine unit 101 includes an engine control CPU 102 configured to control the operation of the image forming engine unit 101, a ROM 103 in which a control program and control data for the engine control CPU 102 are stored, sensors 350 for controlling the image forming engine unit 101, a timer 360 configured to measure an operation time of the image forming engine unit 101, an environment sensor 370, a RAM 104 configured to be used as a work memory for the control program and to store measured values of the sensors 350, the timer, and the environment sensor 370. The environment sensor 370 can obtain information such as temperature or humidity within the image forming engine unit 101. This information is used to control the image forming engine unit 101 during a print processing operation performed by the image forming apparatus 100, which will be described next. The image forming engine unit 101 controls the image forming process described in FIG. 2.

FIG. 2 is a cross-sectional view illustrating a structure of the image forming apparatus 100 according to the present embodiment. As illustrated, the image forming apparatus 100 includes a casing 201. The casing 201 houses mechanisms constituting the image forming engine unit 101, the engine control CPU 102 configured to control print processing (for example, paper feeding processing) performed by the mechanisms, and a control board housing unit configured to house the controller 300. The scanner 171 is mounted on the casing 201.

The mechanisms constituting the image forming engine unit 101 include: an optical processing mechanism configured to form an electrostatic latent image on a photosensitive drum 205 by scanning with laser light, to develop the electrostatic latent image into a visible image, to transfer the visible image onto an intermediate transfer member 252 in an overlapped manner, and to further transfer the overlapped color image onto a sheet P; a fixing mechanism configured to fix the toner image transferred onto the sheet P; a sheet feeding mechanism configured to feed the sheet P; and a conveying mechanism configured to convey the sheet P.

The optical processing mechanism includes, in a laser scanner unit 207, a laser driver configured to turn on and off laser light emitted from a semiconductor laser (not shown) in accordance with image data supplied from the controller 300. The laser light emitted from the semiconductor laser is deflected in a main scanning direction by a rotating polygon mirror 208. The laser light deflected in a main scanning direction is guided to the photosensitive drum 205 via a reflecting polygon mirror 209 and exposes the photosensitive drum 205 in the main scanning direction. The electrostatic latent image formed on the photosensitive drum 205 by scanning exposure with laser light after the photosensitive drum 205 is charged by a primary charger 211 is developed into a toner image by toner supplied from a developing unit 212, which will be described below. The developed toner image on the photosensitive drum 205 is transferred (primary transfer) onto the intermediate transfer member 252 to which a voltage having a polarity opposite to that of the toner image is applied. In color image formation, respective color toner images are sequentially formed on the intermediate transfer member 252 by a yellow (Y) station 220, a magenta (M) station 221, a cyan (C) station 222, and a black (K) station 223. As a result, a full-color visible image is formed on the intermediate transfer member 252. A density sensor 230 configured to measure density of each patch during density control is also disposed. During density control, density of each patch is detected by the density sensor 230. During color misregistration correction control, an edge of each color patch is detected by the density sensor 230.

Next, the sheet P fed from a sheet cassette 210 is conveyed, and is pressed against the intermediate transfer member 252 by a transfer roller 251. At the same time, by applying, to the transfer roller 251, a bias having a polarity opposite to that of the toner, the visible image formed on the intermediate transfer member 252 is transferred (secondary transfer) onto the sheet P conveyed synchronously in a conveyance direction of the sheet P (sub-scanning direction) by the sheet feeding mechanism.

When the sheet P subjected to secondary transfer passes through a fixing unit 260, the toner transferred onto the sheet P is heated and melted, and is fixed to the sheet P as an image. In the case of double-sided printing, the sheet P is switchback reversed through a reversing section 270, and is again conveyed to the transfer roller 251, so that a back-side image is transferred onto the sheet P. Thereafter, the sheet P passes through the fixing unit 260 as described above, so that the toner image on the sheet P is fixed by heating, and the sheet P is discharged to a sheet discharge unit 280, thereby completing the printing process.

A cleaning device is provided for each photosensitive drum 205, and collects transfer residual toner remaining on the photosensitive drum 205 after transfer to the intermediate transfer member 252 by bringing a cleaning blade into sliding contact with the photosensitive drum 205. A belt cleaning device is provided for the intermediate transfer member 252, and collects transfer residual toner remaining on the intermediate transfer member 252 after transfer to the sheet P by bringing a cleaning blade into sliding contact with the intermediate transfer member 252.

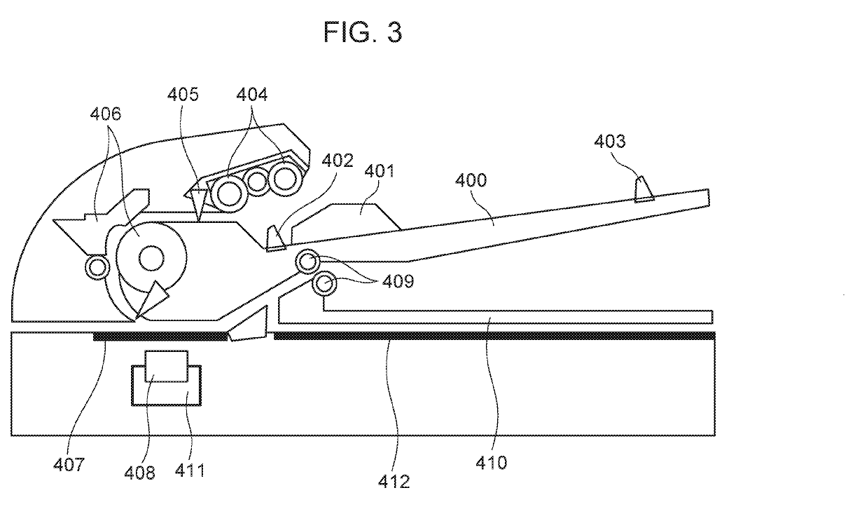

FIG. 3 is a side cross-sectional view illustrating an internal structure of the scanner 171. The scanner 171 includes a document tray 400 on which a document to be automatically read is placed, a document sensor 402 configured to detect whether a document is present on the document tray 400, two document guides 401, and a document-size detection sensor 403. The two document guides 401 are arranged side by side in a document width direction (perpendicularly to a document conveyance direction). The document placed on the document tray 400 is conveyed by a pickup roller 404, a conveyance roller 406, and a discharge roller 409. The pickup roller 404 is a roller configured to convey a document placed on the document tray 400 into a document conveyance path inside an automatic document feeder (ADF) unit. The conveyance roller 406 conveys a document conveyed into the document conveyance path by the pickup roller 404, and the discharge roller 409 conveys the document conveyed by the conveyance roller 406 to a discharge tray 410. The document conveyed by the pickup roller 404 is detected by a document passage detection sensor 405. Whether passage of the first document has been completed is determined based on a detection time. Although not shown, the conveyance roller 406, the pickup roller 404, and the discharge roller 409 are all driven by a stepping motor. The conveyed document is read through a reading window 407 by a contact image sensor (CIS) 408 in a sensor unit 411 disposed below the reading window 407. The sensor unit 411 is freely movable in the sub-scanning direction, and is also movable in the same direction as the conveyance direction of a document conveyed from the conveyance roller 406 toward the discharge roller 409. The reading window 407 has a predetermined length in the sub-scanning direction, and the CIS 408 can be moved to any position within the length to read a document at the position. The CIS 408 includes photoelectric conversion elements such as charge-coupled devices (CCDs), a first-in first-out (FIFO) memory configured to accumulate image signals from the elements, and a control signal generation circuit configured to generate control signals for controlling the FIFO memory and the CCDs. The CIS 408 is generally implemented in a form in which a plurality of photoelectric conversion elements are arranged in a single row. Although not illustrated, the sensor unit 411 includes a light source configured to illuminate a document through the reading window 407 or a platen reading window 412, and is generally implemented in a form in which a plurality of light sources are arranged in a single row. A light-emitting diode (LED) is one example of the light source; however, another type of light source may be used.

When a user places a document on the platen instead of on the document tray 400, the sensor unit 411 is moved to a position below the platen reading window 412, and the CIS 408 reads the document through the platen reading window 412 while the sensor unit 411 is moved in the sub-scanning direction. The read image data is stored in the RAM 307 or an image memory dedicated to storing image data (not shown).

The image forming apparatus 100 according to the present embodiment includes: (1) correction (hereinafter referred to as patch correction) configured to form, on the intermediate transfer member 252, a patch image for gradation correction and update the γLUT based on a density value read by the density sensor 230; and (2) automatic gradation correction configured to perform correction by printing a correction pattern image on a sheet and reading the correction pattern image with a reading device such as the scanner 171. The details of updating the γLUT in patch correction and automatic gradation correction are disclosed in Japanese Patent Laid-Open No. 2023-12287, and thus will be omitted here. The updated γLUT is stored in the HDD 302 or the RAM 307.

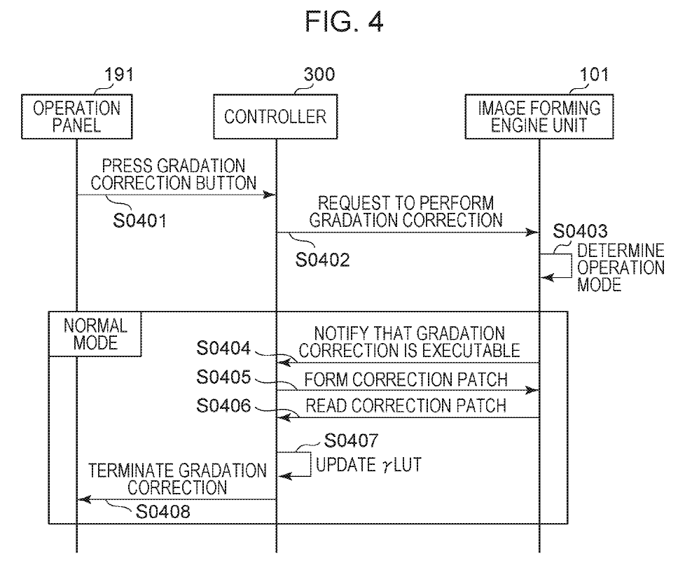

FIG. 4 is a sequence diagram illustrating a series of processes in normal patch correction according to the present embodiment. In patch correction, main communication is performed among the operation panel 191, the controller 300, and the image forming engine unit 101.

First, when a user presses a gradation correction (patch correction) button on the operation panel 191 in S0401, the controller 300 starts patch correction processing. In S0402, the controller CPU 311 requests the engine control CPU 102 of the image forming engine unit 101, via the engine I/F unit 316, to perform gradation correction (patch correction).

In S0403, the engine control CPU 102 determines an operation mode of the image forming engine unit 101. An operation mode of the image forming engine unit 101 is determined by comparing, with predetermined values, values such as the temperature and humidity of the image forming engine unit 101 obtained from the sensors 350 and the environment sensor 370 of the image forming engine unit 101. Specifically, an operation mode is determined based on a threshold stored in the ROM 103 of the image forming engine unit 101. When the detected temperature is less than or equal to the threshold, the operation mode is set to a low-temperature mode; otherwise, the operation mode is set to a normal mode.

If the operation mode of the image forming engine unit 101 is the normal mode, in S0404, the engine control CPU 102 notifies the controller CPU 311, via the engine I/F unit 316, that gradation correction (patch correction) can be performed. In response to this notification, in S0405, the controller CPU 311 generates a specific pattern image to be used for correction, transfers the specific pattern image to the image forming engine unit 101 via the engine I/F unit 316, and causes a toner image to be formed on the intermediate transfer member 252.

In S0406, the engine control CPU 102 reads the density of the toner image with the density sensor 230 and notifies the controller CPU 311 of the density value. In S0407, the controller CPU 311 obtains, from the density data received from the engine control CPU 102 and a current γLUT stored in the HDD 302 or the RAM 307, a target for patch-based gradation correction, and updates the γLUT using the gradation correction table generation unit 306. The updated γLUT is stored in the HDD 302 or the RAM 307. During normal printing on a sheet, the controller CPU 311 transfers, to the image forming engine unit 101, an image subjected to gradation correction by the gradation correction unit 314 with reference to the γLUT stored in the HDD 302 or the RAM 307. Upon completion of updating the γLUT, in S0408, the controller CPU 311 notifies the operation panel 191 that gradation correction (patch correction) has been completed.

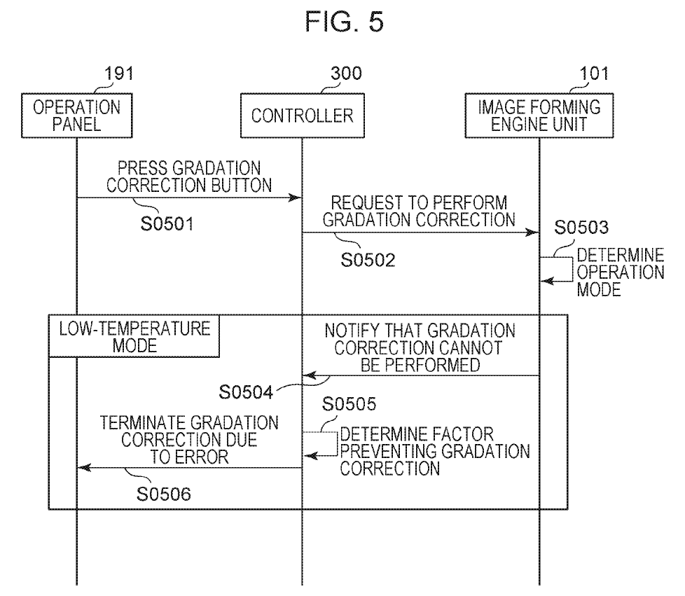

FIG. 5 is a sequence diagram illustrating a series of processes performed when patch correction is prohibited in the present embodiment.

First, when a user presses a gradation correction (patch correction) button on the operation panel 191 in S0501, the controller 300 starts patch correction processing. In S0502, the controller CPU 311 requests the engine control CPU 102 of the image forming engine unit 101, via the engine I/F unit 316, to perform gradation correction (patch correction).

In S0503, the engine control CPU 102 determines an operation mode of the image forming engine unit 101. An operation mode of the image forming engine unit 101 is determined based on information such as the temperature and humidity of the image forming engine unit 101 obtained from the sensors 350 and the environment sensor 370 of the image forming engine unit 101. Specifically, an operation mode is determined based on a threshold stored in the ROM 103 of the image forming engine unit 101. When the detected temperature is less than or equal to the threshold, the operation mode is set to a low-temperature mode; otherwise, the operation mode is set to a normal mode.

A threshold temperature for the low-temperature mode differs depending on characteristics of the image forming engine unit 101. For example, when the temperature detected by the environment sensor 370 is less than or equal to 7° C, the operation mode is set to the low-temperature mode. In an environment in which the image forming engine unit 101 operates in the low-temperature mode, the elasticity of the cleaning blade configured to collect toner remaining on the intermediate transfer member 252 decreases, so that the toner cannot be normally collected. In particular, the patch correction processing differs from normal printing in which only transfer residual toner remaining on the intermediate transfer member 252 is collected. During patch correction, it is necessary to collect the toner of a specific pattern image used for correction formed on the intermediate transfer member 252, and thus more toner is collected than during normal printing. For this reason, in an environment in which the image forming engine unit 101 operates in the low-temperature mode, the toner of a toner image formed on the intermediate transfer member 252 for patch correction cannot be sufficiently collected, and thus toner is likely to remain on the intermediate transfer member 252. The toner remaining on the intermediate transfer member 252 may be transferred onto a sheet in normal printing performed after patch correction, thereby causing a print output to fail to be a normal image. For this reason, if the engine control CPU 102 determines, in S0503, that an operation mode of the image forming engine unit 101 is the low-temperature mode, the engine control CPU 102 notifies the controller CPU 311, in S0504, via the engine I/F unit b, that gradation correction (patch correction) cannot be performed. In this case, the engine control CPU 102 also notifies the controller CPU 311 of a factor that prevents patch correction.

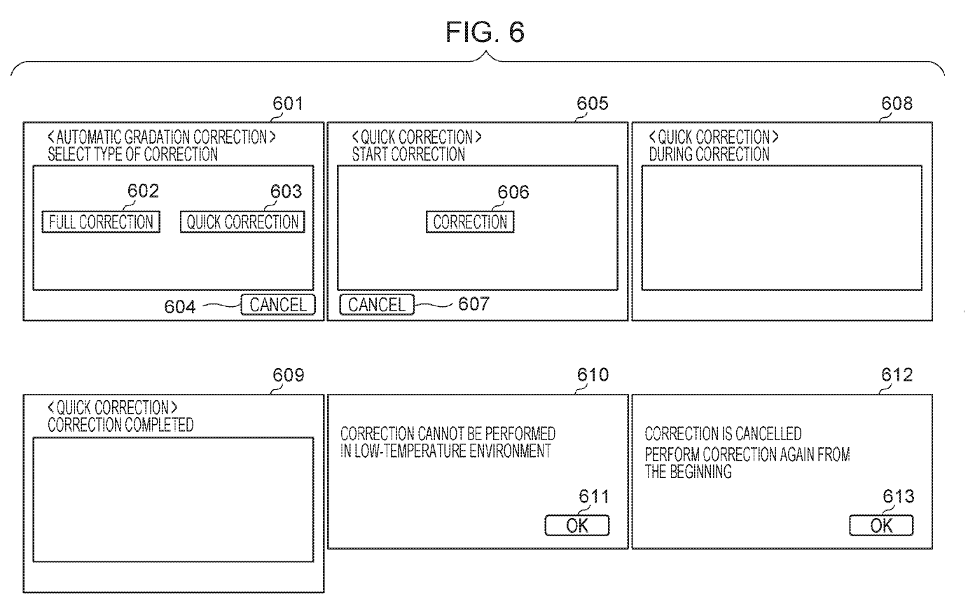

In response to the notification, in S0505, the controller CPU 311 determines a factor that prevents gradation correction (patch correction), based on the notification received from the engine control CPU 102. In S0506, the controller CPU 311 displays, on the operation panel 191, an error indication corresponding to the factor determined in S0505, and notifies a user of termination of gradation correction (patch correction) due to the error. When gradation correction (patch correction) cannot be performed because the operation mode of the image forming engine unit 101 is the low-temperature mode, described above, an error indication is displayed indicating that gradation correction (patch correction) cannot be performed due to a low-temperature environment of the image forming apparatus 100. The error indication informs the user that gradation correction (patch correction) cannot be performed in the current environment. One example of the error indication is shown in a screen 610 of FIG. 6.

In the above description of the sequence, a low-temperature environment is given as a factor that prevents gradation correction (patch correction); however, there may be other factors that prevent normal performance of gradation correction (patch correction), and control may be performed according to the above sequence also for such factors. For example, when condensation is inferred to occur in the image forming engine unit 101 based on changes in temperature and humidity of the image forming engine unit 101 obtained from the environment sensor 370, such a condition may also be regarded as a factor that prevents normal performance of gradation correction (patch correction).

FIG. 6 illustrates examples of screens displayed on the operation panel 191 in the sequences of FIGS. 4 and 5 described above.

In performing gradation correction (patch correction), a screen 601 is first displayed on the operation panel 191 by the controller CPU 311. A full correction button 602 is a button configured to receive an instruction to perform automatic gradation correction in which a correction pattern image is printed on a sheet. A quick correction button 603 is a button configured to receive an instruction to perform patch correction in which a correction patch image is formed on the intermediate transfer member 252. The user can select either one. A cancel button 604 is a button configured to cancel performance of automatic gradation correction. When the user presses the quick correction button 603, the controller CPU 311 displays a screen 605 on the operation panel 191. When the user presses a correction button 606, processing for patch correction by the controller 300 is started in S0401 and S0501 of the above sequences. A cancel button 607 is a button configured to cancel performance of patch correction. A screen 608 is a screen displayed on the operation panel 191 while processing for gradation correction (patch correction) is being performed in S0402 to S0407 and S0502 to S0505 of the above sequence. When the controller CPU 311 notifies normal completion of gradation correction (patch correction) in S0408, a screen 609 is displayed on the operation panel 191. In contrast, when it is determined in S0505 that gradation correction (patch correction) cannot be performed because the operation mode of the image forming engine unit 101 is the low-temperature mode, the controller CPU 311 displays the screen 610 on the operation panel 191. The screen 610 indicates that patch correction cannot be performed because the image forming apparatus 100 is in a low-temperature environment. An OK button 611 is a button for closing the error screen 610. When it is determined that patch correction cannot be performed due to another factor, the controller CPU 311 displays a screen 612 on the operation panel 191 and notifies an error. An OK button 613 is a button for closing the error screen 612. There may be multiple screens for notifying that patch correction cannot be performed, depending on factors that prevent patch correction.

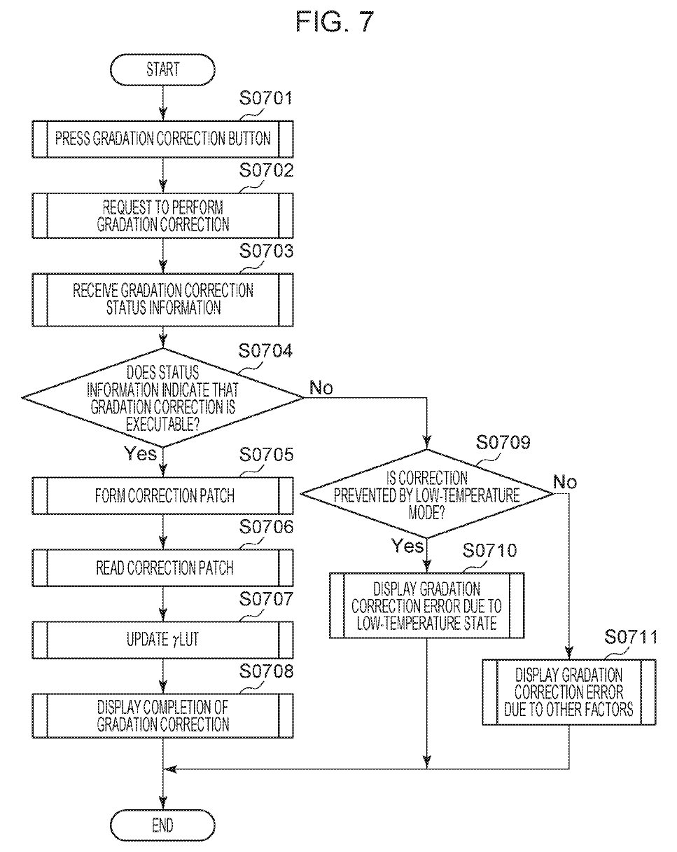

FIG. 7 is a detailed flowchart of patch correction processing according to the present embodiment, for which sequences are shown in FIGS. 4 and 5. Each process of the flowchart of FIG. 7 is implemented by the controller CPU 311 reading a program stored in the HDD 302 into the RAM 307 and executing the program.

In S0701, the controller CPU 311 displays the screens 601 and 605 on the operation panel 191. Upon detecting that the patch correction button 606 has been pressed by the user, the controller CPU 311 requests, in S0702, the engine control CPU 102 via the engine I/F unit 316 to perform gradation correction (patch correction). In response to the request to perform gradation correction (patch correction), the engine control CPU 102 determines an operation mode of the image forming engine unit 101. In S0703, the controller CPU 311 receives, via the engine I/F unit 316, status information notified from the engine control CPU 102 indicating whether gradation correction (patch correction) can be performed.

In S0704, if the controller CPU 311 determines that the received status information indicates that patch correction can be performed (Yes in S0704), the process proceeds to S0705. In S0705, the controller CPU 311 generates a specific pattern image to be used for correction, transfers the specific pattern image to the image forming engine unit 101 via the engine I/F unit 316, and causes a toner image to be formed on the intermediate transfer member 252. In S0706, the controller CPU 311 receives, via the engine I/F unit 316 from the engine control CPU 102, a value obtained by reading, with the density sensor 230, the toner image formed on the intermediate transfer member 252. In S0707, the controller CPU 311 obtains a target for patch-based gradation correction based on the density data received in S0706 and the current γLUT stored in the HDD 302 or the RAM 307, and updates the γLUT. The controller CPU 311 stores the updated γLUT in the HDD 302 or the RAM 307. Thus, since the patch correction has been completed, in S0708, the controller CPU 311 displays the screen 609 on the operation panel 191, notifies the user of completion of the patch correction, and terminates the patch correction processing.

In contrast, in S0704, if the controller CPU 311 determines that the received status information indicates that patch correction cannot be performed (No in S0704), the process proceeds to S0709. In S0709, the controller CPU 311 determines a factor that prevents patch correction based on the information notified from the engine control CPU 102 in S0703. If the operation mode of the image forming engine unit 101 notified from the engine control CPU 102 is the low-temperature mode (Yes in S0709), the controller CPU 311 displays the screen 610 on the operation panel 191 in S0710. The screen 610 is a screen for notifying the user that patch correction cannot be performed because the image forming apparatus 100 is in a low-temperature environment. Accordingly, the controller CPU 311 terminates the patch correction processing.

In contrast, if the operation mode of the image forming engine unit 101 notified from the engine control CPU 102 is a mode other than the low-temperature mode (No in S0709), the controller CPU 311 displays the screen 612 on the operation panel 191 in S0711. The screen 612 is a screen for notifying the user that patch correction cannot be performed due to some factor. Accordingly, the controller CPU 311 terminates the patch correction processing. Here, description has been made of a case in which two types of factors that prevent patch correction are notified from the engine control CPU 102; however, three or more types of factors may exist.

In order to cope with a temperature change over time, if the operation mode of the image forming engine unit 101 notified from the engine control CPU 102 is a mode other than the low-temperature mode (No in S0709), the determination in S0709 may be performed again after a predetermined time has elapsed. When the operation mode of the image forming engine unit 101 is a mode other than the low-temperature mode, the process may proceed to S0711. In addition, after a predetermined time has elapsed after the operation mode is determined to be the low temperature mode, steps S0703 and S0704 may be performed again such that the controller CPU 311 determines whether the status information indicates that patch correction can be performed.

In S0704, the controller CPU 311 may display, on the operation panel 191, a determination result indicating whether patch correction can be performed, based on the received status information. This display may notify the user that gradation correction can be performed or cannot be performed.

Accordingly, in a situation in which a pattern image formed on the intermediate transfer member cannot be sufficiently removed in a low-temperature environment, gradation correction (patch correction) is not performed. As a result, it is possible to prevent occurrence of a phenomenon in which a pattern image remaining on the intermediate transfer member is transferred to a sheet and an output image is not properly formed.

### Second Embodiment

Hereinafter, an embodiment of the present disclosure in which automatic gradation correction is performed by printing a correction pattern image on a sheet and reading the correction pattern image with a reading device such as the scanner 171 will be described with reference to the drawings.

Only differences from the first embodiment will be described below.

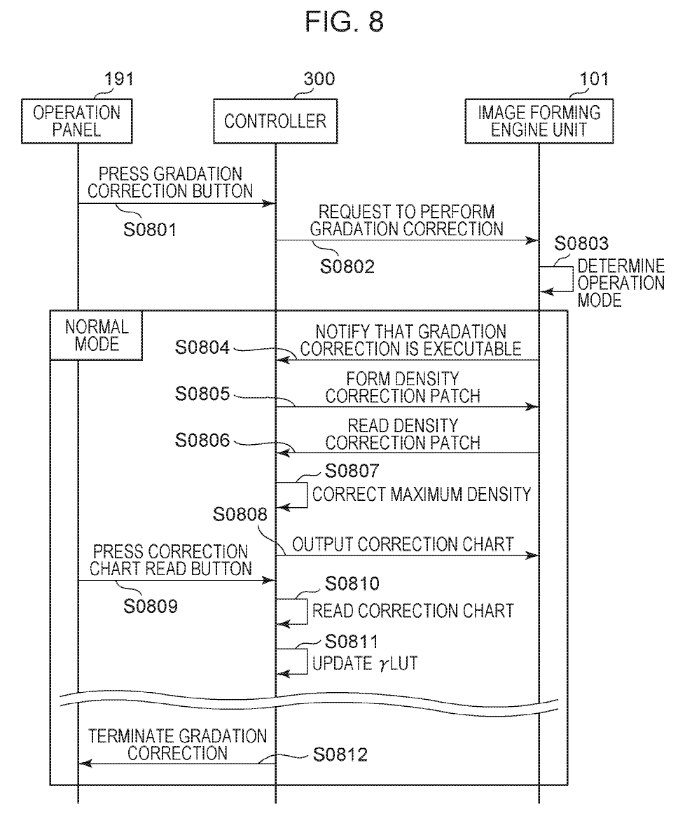

FIG. 8 is a sequence diagram illustrating a series of processes for normal automatic gradation correction according to the present embodiment. In automatic gradation correction, main communication is performed among the operation panel 191, the controller 300, and the image forming engine unit 101.

First, when a user presses, in S0801, a gradation correction (full correction) button on the operation panel 191, the controller 300 starts gradation correction processing. In S0802, the controller CPU 311 requests the engine control CPU 102 of the image forming engine unit 101, via the engine I/F unit 316, to perform gradation correction (full correction). In S0803, the engine control CPU 102 determines an operation mode of the image forming engine unit 101. An operation mode of the image forming engine unit 101 is determined based on information such as the temperature and humidity of the image forming engine unit 101 obtained from the sensors 350 and the environment sensor 370 of the image forming engine unit 101. Specifically, an operation mode is determined based on a threshold stored in the ROM 103 of the image forming engine unit 101. When the detected temperature is less than or equal to the threshold, the operation mode is set to a low-temperature mode; otherwise, the operation mode is set to a normal mode.

If the operation mode of the image forming engine unit 101 is an operation mode (normal mode) in which gradation correction (full correction) can be performed, in S0804, the engine control CPU 102 notifies the controller CPU 311, via the engine I/F unit 316, that gradation correction (full correction) can be performed. In response to this notification, in S0805, the controller CPU 311 generates a specific pattern image to be used to correct maximum density, transfers the specific pattern image to the image forming engine unit 101 via the engine I/F unit 316, and causes a toner image to be formed on the intermediate transfer member 252. In S0806, the engine control CPU 102 reads the density of the toner image with the density sensor 230 and notifies the controller CPU 311 of the density value. Next, in S0807, the controller CPU 311 adjusts the maximum density based on the received density data using the maximum density condition determination unit 304. Next, in S0808, the controller CPU 311 generates a specific pattern image to be used for gradation correction, transfers the specific pattern image to the image forming engine unit 101 via the engine I/F unit 316, and forms a toner image on the sheet P.

The sheet P on which the specific pattern image is formed is placed in the scanner 171 by the user. In S0809, when the user presses a correction chart reading button on the operation panel 191, the controller CPU 311 requests the scanner 171 in S0810 to perform reading. The scanner 171 reads the specific pattern image formed on the sheet P. The image data read by the scanner 171 is transferred to the controller 300 via the scanner I/F unit 318. In S0811, the controller CPU 311 obtains a target for patch-based gradation correction based on the transferred image data and the current γLUT stored in the HDD 302 or the RAM 307, and updates the γLUT using the gradation correction table generation unit 306. The updated γLUT is stored in the HDD 302 or the RAM 307. During normal printing on a sheet, the controller CPU 311 transfers, to the image forming engine unit 101, an image subjected to gradation correction by the gradation correction unit 314 with reference to the γLUT stored in the HDD 302 or the RAM 307. The processes from S0808 through S0811 may be performed multiple times while changing a specific pattern image for gradation correction. Upon completion of updating the γLUT, in S0812, the controller CPU 311 notifies the operation panel 191 that gradation correction (full correction) has been completed.

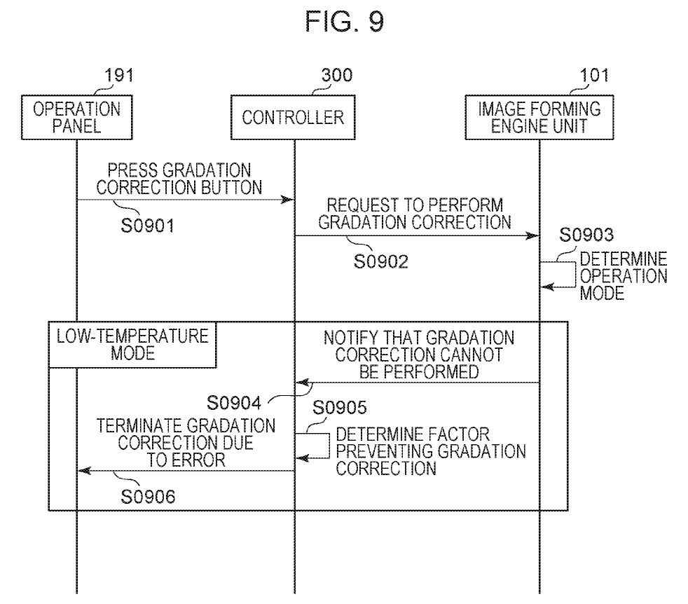

FIG. 9 is a sequence diagram illustrating a series of processes performed when gradation correction is prohibited in normal automatic gradation correction according to the present embodiment.

First, when a user presses, in S0901, a gradation correction (full correction) button on the operation panel 191, the controller 300 starts gradation correction processing. In S0902, the controller CPU 311 requests the engine control CPU 102 of the image forming engine unit 101, via the engine I/F unit 316, to perform gradation correction (full correction). In S0903, the engine control CPU 102 determines an operation mode of the image forming engine unit 101. An operation mode of the image forming engine unit 101 is determined based on information such as the temperature and humidity of the image forming engine unit 101 obtained from the sensors 350 and the environment sensor 370 of the image forming engine unit 101. Specifically, an operation mode is determined based on a threshold stored in the ROM 103 of the image forming engine unit 101. When the detected temperature is less than or equal to the threshold, the operation mode is set to a low-temperature mode; otherwise, the operation mode is set to a normal mode. A threshold temperature for the low-temperature mode differs depending on characteristics of the image forming engine unit 101. For example, when the temperature detected by the environment sensor 370 is less than or equal to 7° C, the operation mode is set to the low-temperature mode.

In S0903, if the engine control CPU 102 determines that an operation mode of the image forming engine unit 101 is the low-temperature mode, the engine control CPU 102 notifies the controller CPU 311, in S0904, via the engine I/F unit 316, that gradation correction (full correction) cannot be performed. In this case, the engine control CPU 102 also notifies the controller CPU 311 of a factor that prevents full correction.

In response to the notification, in S0905, the controller CPU 311 determines a factor that prevents gradation correction (full correction), based on the notification received from the engine control CPU 102. In S0906, the controller CPU 311 displays, on the operation panel 191, an error indication corresponding to the factor determined in S0905, and notifies a user of termination of gradation correction (full correction) due to the error. When gradation correction (full correction) cannot be performed because the operation mode of the image forming engine unit 101 is the low-temperature mode, described above, an error indication is displayed indicating that gradation correction (full correction) cannot be performed due to a low-temperature environment of the image forming apparatus 100. The error indication informs the user that gradation correction (full correction) cannot be performed in the current environment. One example of the error indication is shown in the screen 610 of FIG. 6.

In the above description of the sequence, a low-temperature environment is given as a factor that prevents gradation correction (full correction); however, there may be other factors that prevent normal performance of gradation correction (full correction), and control may be performed according to the above sequence also for such factors. For example, when condensation is inferred to occur in the image forming engine unit 101 based on changes in temperature and humidity of the image forming engine unit 101 obtained from the environment sensor 370, such a condition may also be regarded as a factor that prevents normal performance of gradation correction (full correction).

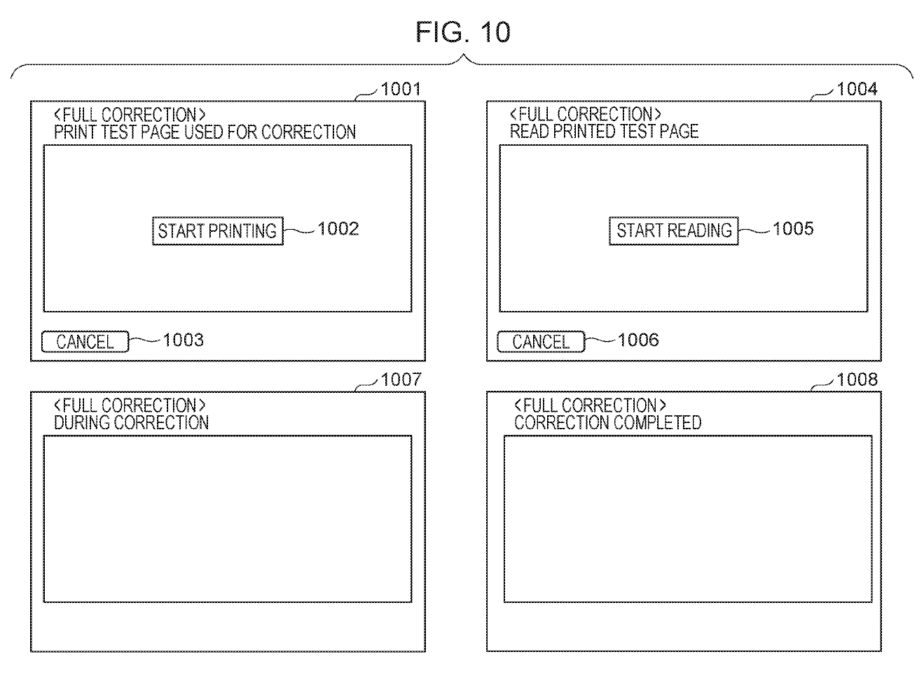

FIG. 10 illustrates examples of screens displayed on the operation panel 191 in the sequences of FIGS. 8 and 9 described above. Examples of screens common to the first embodiment are illustrated in FIG. 6.

In performing gradation correction (full correction), the screen 601 is first displayed on the operation panel 191 by the controller CPU 311. When the user presses the full correction button 602, the controller CPU 311 displays a screen 1001 on the operation panel 191. When the user presses a printing start button 1002, gradation correction processing is started by the controller 300 in S0801 and S0901 of the above sequences. A cancel button 1003 is a button configured to cancel performance of gradation correction.

A screen 1004 is a screen displayed on the operation panel 191 after the specific pattern image to be fused for gradation correction is formed on the sheet P in S0808 of the above sequence. When the user presses a reading start button 1005, the controller CPU 311 reads the specific pattern image in S0810 of the above sequence. A cancel button 1006 is a button configured to cancel performance of gradation correction. A screen 1007 is a screen displayed on the operation panel 191 while gradation correction (full correction) processing is performed in S0810 to S0811 in the above sequence. In S0812, when the controller CPU 311 notifies normal termination of gradation correction (full correction), a screen 1008 is displayed on the operation panel 191. In contrast, when an operation mode of the image forming engine unit 101 is the low-temperature mode, and therefore it is determined in S0905 that gradation correction (full correction) cannot be performed, the controller CPU 311 displays the screen 610 on the operation panel 191. The screen 610 is a screen that indicates that full correction cannot be performed because the image forming apparatus 100 is in a low-temperature environment. The OK button 611 is a button for closing the error screen 610. When it is determined that full correction cannot be performed due to another factor, the controller CPU 311 displays the screen 612 on the operation panel 191 and notifies an error. The OK button 613 is a button for closing the error screen 612. There may be multiple screens for notifying that full correction cannot be performed, depending on factors that prevent full correction.

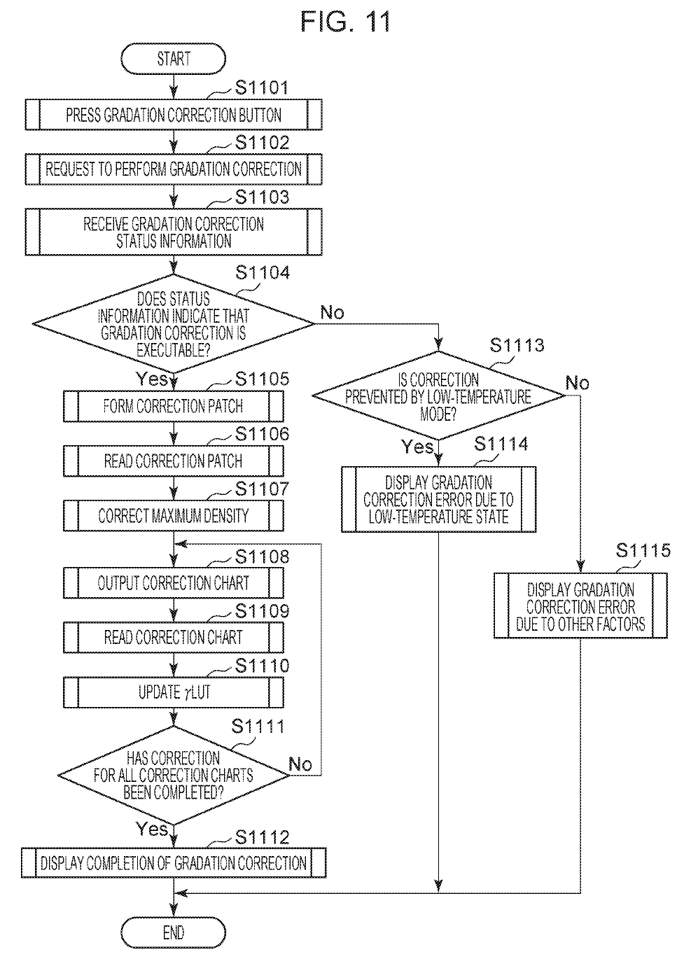

FIG. 11 is a detailed flowchart of full correction processing according to the present embodiment, for which sequences are shown in FIGS. 8 and 9. Each process of the flowchart of FIG. 11 is implemented by the controller CPU 311 reading a program stored in the HDD 302 into the RAM 307 and executing the program.

In S1101, the controller CPU 311 displays the screens 601 and 1001 on the operation panel 191, and detects that a full correction chart printing start button 1002 has been pressed by the user. In S1102, the controller CPU 311 requests the engine control CPU 102 of the image forming engine unit 101 via the engine I/F unit 316 to perform gradation correction (full correction). In response to the request to perform gradation correction (full correction), the engine control CPU 102 determines an operation mode of the image forming engine unit 101. In S1103, the controller CPU 311 receives, via the engine I/F unit 316, status information notified from the engine control CPU 102 indicating whether gradation correction (full correction) can be performed.

In S1104, if the controller CPU 311 determines that the received status information indicates that full correction can be performed (Yes in S1104), the process proceeds to S1105. In S1105, the controller CPU 311 generates a specific pattern image to be used for maximum density correction, transfers the specific pattern image to the image forming engine unit 101 via the engine I/F unit 316, and causes a toner image to be formed on the intermediate transfer member 252. In S1106, the controller CPU 311 receives, via the engine I/F unit b from the engine control CPU 102, a value obtained by reading, with the density sensor 230, the toner image formed on the intermediate transfer member 252. In S1107, the controller CPU 311 performs maximum density adjustment using the maximum density condition determination unit 304 based on the density data received in S1106.

Next, in S1108, the controller CPU 311 generates a specific pattern image to be used for gradation correction, transfers the specific pattern image to the image forming engine unit 101 via the engine I/F unit 316, forms a toner image on the sheet P, and outputs a correction chart. In S1109, upon detecting that the correction chart reading start button 1005 has been pressed by the user, the controller CPU 311 requests the scanner 171 to perform reading. The scanner 171 receives image data of the read correction chart via the scanner I/F unit 318.

In S1110, the controller CPU 311 updates the γLUT based on the image data received in S1109 and the current γLUT stored in the HDD 302 or the RAM 307. The controller CPU 311 stores the updated γLUT in the HDD 302 or the RAM 307. The correction processing using the correction chart in S1108 to S1110 may be performed multiple times while changing a specific pattern image to be used for gradation correction. Accordingly, in S1111, the controller CPU 311 determines whether correction processing has been completed for all correction charts. If correction processing has not been completed in S1111 (No in S1111), the process returns to S1108, where the controller CPU 311 generates a specific pattern image to be used for gradation correction different from that used previously, outputs a correction chart, and repeats the correction processing. In contrast, if correction processing has been completed in S1111 (Yes in S1111), the controller CPU 311 displays the screen 1008 on the operation panel 191 in S1112, notifies the user of completion of the full correction, and terminates the full correction processing.

In contrast, in S1104, if the controller CPU 311 determines that the received status information indicates that full correction cannot be performed (No in S1104), the process proceeds to S1113. In S1113, the controller CPU 311 determines a factor that prevents full correction based on the information notified from the engine control CPU 102. If the operation mode of the image forming engine unit 101 notified from the engine control CPU 102 is the low-temperature mode (Yes in S1113), the controller CPU 311 displays the screen 610 on the operation panel 191 in S1114. The screen 610 is a screen for notifying the user that full correction cannot be performed because the image forming apparatus 100 is in a low-temperature environment. Accordingly, the controller CPU 311 terminates the full correction processing.

In contrast, if the operation mode of the image forming engine unit 101 notified from the engine control CPU 102 is a mode other than the low-temperature mode (No in S1113), the controller CPU 311 displays the screen 612 on the operation panel 191 in S1115. The screen 612 is a screen for notifying the user that full correction cannot be performed due to some factor. Accordingly, the controller CPU 311 terminates the full correction processing. Here, description has been made of a case in which two types of factors that prevent full correction are notified from the engine control CPU 102; however, three or more types of factors may exist.

Accordingly, in a situation in which a pattern image formed on the intermediate transfer member cannot be sufficiently removed in a low-temperature environment, gradation correction (full correction) is not performed. As a result, it is possible to prevent occurrence of a phenomenon in which a pattern image remaining on the intermediate transfer member is transferred to a sheet and an output image is not properly formed.

### Third Embodiment

Hereinafter, an embodiment of the present disclosure in which color misregistration correction is performed will be described with reference to the drawings.

Only differences from the first embodiment will be described below.

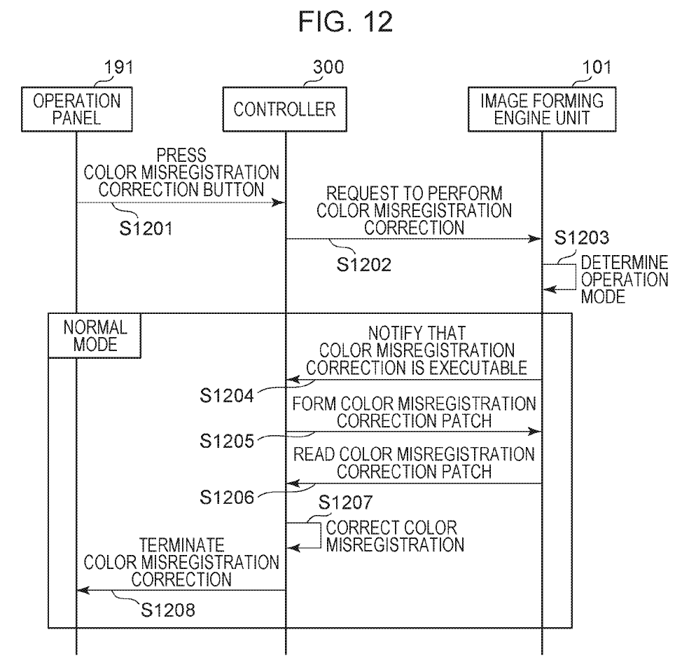

FIG. 12 is a sequence diagram illustrating a series of processes for normal color misregistration correction according to the present embodiment.

In color misregistration correction, main communication is performed among the operation panel 191, the controller 300, and the image forming engine unit 101.

First, when a user presses, in S1201, an automatic color misregistration correction button on the operation panel 191, the controller 300 starts color misregistration correction processing. In S1202, the controller CPU 311 requests the engine control CPU 102 of the image forming engine unit 101, via the engine I/F unit 316, to perform color misregistration correction. In S1203, the engine control CPU 102 determines an operation mode of the image forming engine unit 101. An operation mode of the image forming engine unit 101 is determined based on information such as the temperature and humidity of the image forming engine unit 101 obtained from the sensors 350 and the environment sensor 370 of the image forming engine unit 101. Specifically, an operation mode is determined based on a threshold stored in the ROM 103 of the image forming engine unit 101. When the detected temperature is less than or equal to the threshold, the operation mode is set to a low-temperature mode; otherwise, the operation mode is set to a normal mode.

If the operation mode of the image forming engine unit 101 is an operation mode (normal mode) in which color misregistration correction can be performed, in S1204, the engine control CPU 102 notifies the controller CPU 311, via the engine I/F unit 316, that color misregistration correction can be performed. In response to this notification, in S1205, the controller CPU 311 generates a specific pattern image to be used for correction, transfers the specific pattern image to the image forming engine unit 101 via the engine I/F unit 316, and causes a toner image to be formed on the intermediate transfer member 252. In S1206, the engine control CPU 102 reads the toner image with the density sensor 230 to detect the edge of the toner image, and notifies the controller CPU 311 of the position of the edge. Next, in S1207, the controller CPU 311 detects color misregistration caused by positional deviations of the respective color patches based on the received positional data of the toner image, and updates a color misregistration correction table. The updated color misregistration correction table is stored in the HDD 302 or the RAM 307. During normal printing on a sheet, the controller CPU 311 transfers, to the image forming engine unit 101, an image subjected to color misregistration correction with reference to the color misregistration correction table stored in the HDD 302 or the RAM 307. Alternatively, the controller CPU 311 may notify the engine control CPU 102 of a value of the color misregistration correction table, and the image forming engine unit 101 may perform color misregistration correction. Upon completion of updating the color misregistration correction table, the controller CPU 311 notifies the operation panel 191 in S1208 that color misregistration correction has been completed.

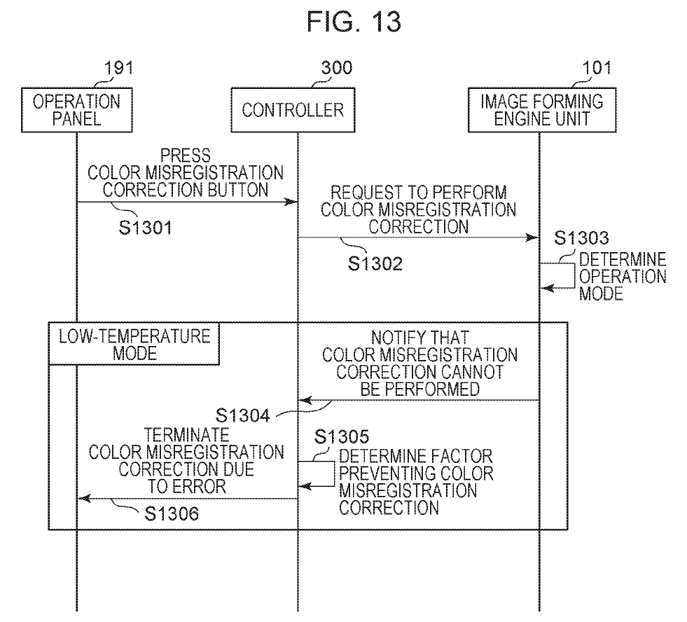

FIG. 13 is a sequence diagram illustrating a series of processes performed when color misregistration correction is prohibited in the present embodiment.

First, when a user presses, in S1301, an automatic color misregistration correction button on the operation panel 191, the controller 300 starts color misregistration correction processing. In S1302, the controller CPU 311 requests the engine control CPU 102 of the image forming engine unit 101, via the engine I/F unit 316, to perform color misregistration correction. In S1303, the engine control CPU 102 determines an operation mode of the image forming engine unit 101. An operation mode of the image forming engine unit 101 is determined based on information such as the temperature and humidity of the image forming engine unit 101 obtained from the sensors 350 and the environment sensor 370 of the image forming engine unit 101. Specifically, an operation mode is determined based on a threshold stored in the ROM 103 of the image forming engine unit 101. When the detected temperature is less than or equal to the threshold, the operation mode is set to a low-temperature mode; otherwise, the operation mode is set to a normal mode.

A threshold temperature for the low-temperature mode differs depending on characteristics of the image forming engine unit 101. For example, when the temperature detected by the environment sensor 370 is less than or equal to 7° C, the operation mode is set to the low-temperature mode. If the engine control CPU 102 determines, in S1303, that an operation mode of the image forming engine unit 101 is the low-temperature mode, the engine control CPU 102 notifies the controller CPU 311, in S1304, via the engine I/F unit 316, that color misregistration correction cannot be performed. In this case, the engine control CPU 102 also notifies the controller CPU 311 of a factor that prevents color misregistration correction.

In response to the notification, in S1305, the controller CPU 311 determines a factor that prevents color misregistration correction, based on the notification received from the engine control CPU 102. In S1306, the controller CPU 311 displays, on the operation panel 191, an error indication corresponding to the factor determined in S1305, and notifies a user of termination of color misregistration correction due to the error. When color misregistration correction cannot be performed because the operation mode of the image forming engine unit 101 is the low-temperature mode, described above, an error indication is displayed indicating that color misregistration correction cannot be performed due to a low-temperature environment of the image forming apparatus 100. The error indication informs the user that color misregistration correction cannot be performed in the current environment. One example of the error indication is shown in a screen 610 of FIG. 6.

In the above description of the sequence, a low-temperature environment is given as a factor that prevents color misregistration correction; however, there may be other factors that prevent normal performance of color misregistration correction, and control may be performed according to the above sequence also for such factors. For example, when condensation is inferred to occur in the image forming engine unit 101 based on changes in temperature and humidity of the image forming engine unit 101 obtained from the environment sensor 370, such a condition may also be regarded as a factor that prevents normal performance of color misregistration correction.

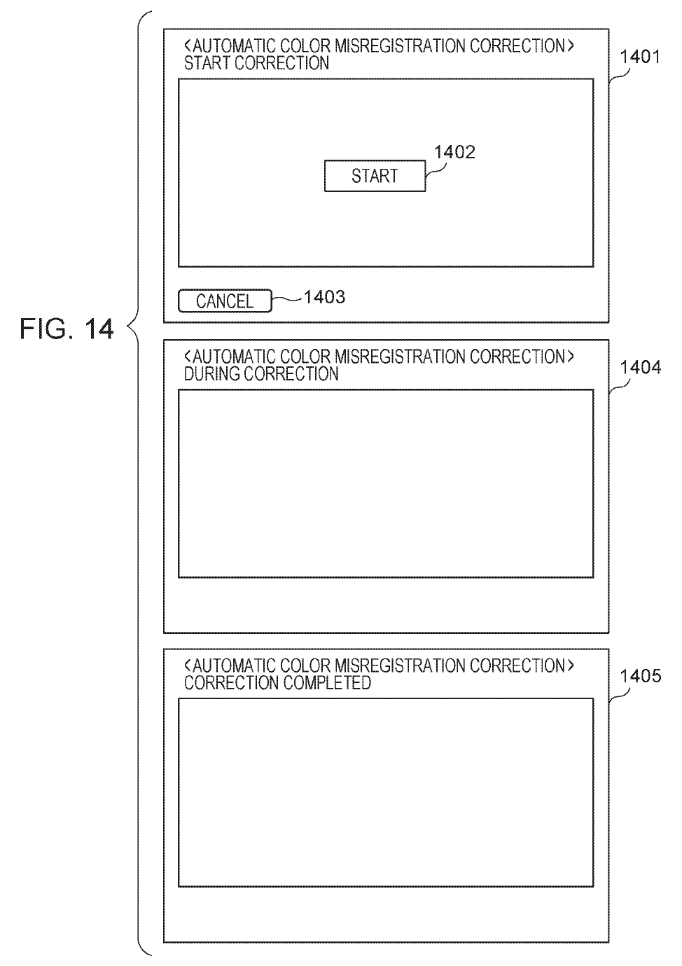

FIG. 14 illustrates examples of screens displayed on the operation panel 191 in the sequences of FIGS. 12 and 13 described above. Examples of screens common to the first embodiment are illustrated in FIG. 6.

In performing color misregistration correction, a screen 1401 is first displayed on the operation panel 191 by the controller CPU 311. When the user presses a start button 1402, color misregistration correction processing is started by the controller 300 in S1201 and S1301 of the above sequences. A cancel button 1403 is a button configured to cancel performance of color misregistration correction.

A screen 1404 is a screen displayed on the operation panel 191 while color misregistration correction is being performed in S1202 to S1207 and S1302 to S1305 of the above sequence. When the controller CPU 311 notifies normal completion of color misregistration correction in S1208, a screen 1405 is displayed on the operation panel 191.

In contrast, when it is determined in S1305 that color misregistration correction cannot be performed because the operation mode of the image forming engine unit 101 is the low-temperature mode, the controller CPU 311 displays the screen 610 on the operation panel 191. The screen 610 indicates that color misregistration correction cannot be performed because the image forming apparatus 100 is in a low-temperature environment. The OK button 611 is a button for closing the error screen 610. When it is determined that color misregistration correction cannot be performed due to another factor, the controller CPU 311 displays the screen 612 on the operation panel 191 and notifies an error. The OK button 613 is a button for closing the error screen 612. There may be multiple screens for notifying that color misregistration correction cannot be performed, depending on factors that prevent color misregistration correction.

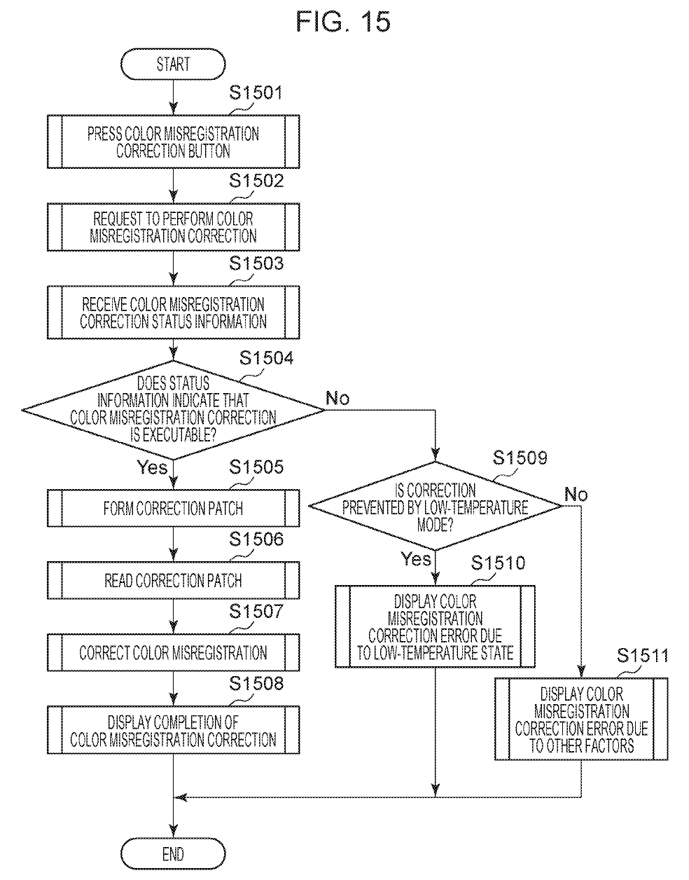

FIG. 15 is a detailed flowchart of color misregistration correction processing according to the present embodiment, for which sequences are shown in FIGS. 12 and 13. Each process of the flowchart of FIG. 15 is implemented by the controller CPU 311 reading a program stored in the HDD 302 into the RAM 307 and executing the program.

In S1501, the controller CPU 311 displays the screen 1401 on the operation panel 191, and detects that the color misregistration correction start button 1402 has been pressed by the user. In S1502, the controller CPU 311 requests the engine control CPU 102 of the image forming engine unit 101 via the engine I/F unit 316 to perform color misregistration correction. In response to the request to perform color misregistration correction, the engine control CPU 102 determines an operation mode of the image forming engine unit 101. In S1503, the controller CPU 311 receives, via the engine I/F unit 316, status information notified from the engine control CPU 102 indicating whether color misregistration correction can be performed.

In S1504, if the controller CPU 311 determines that the received status information indicates that color misregistration correction can be performed (Yes in S1504), the process proceeds to S1505. In S1505, the controller CPU 311 generates a specific pattern image to be used for correction, transfers the specific pattern image to the image forming engine unit 101 via the engine I/F unit 316, and causes a toner image to be formed on the intermediate transfer member 252. In S1506, the controller CPU 311 receives, via the engine I/F unit 316 from the engine control CPU 102, positional information of a toner image formed on the intermediate transfer member 252, the toner image having been read and detected by the density sensor 230. In S1507, the controller CPU 311 detects color misregistration due to positional deviations of the respective color patches based on the positional information of the toner image received in S1506, and updates the color misregistration correction table. The controller CPU 311 stores the updated color misregistration correction table in the RAM 307. Thus, since color misregistration correction has been completed, in S1508, the controller CPU 311 displays a screen 1405 on the operation panel 191, notifies the user of completion of the color misregistration correction, and terminates the color misregistration correction processing.

In contrast, in S1504, if the controller CPU 311 determines that the received status information indicates that color misregistration correction cannot be performed (No in S1504), the process proceeds to S1509. In S1509, the controller CPU 311 determines a factor that prevents color misregistration correction based on the information notified from the engine control CPU 102 in S1503. If the operation mode of the image forming engine unit 101 notified from the engine control CPU 102 is the low-temperature mode (Yes in S1509), the controller CPU 311 displays the screen 610 on the operation panel 191 in S1510. The screen 610 is a screen for notifying the user that color misregistration correction cannot be performed because the image forming apparatus 100 is in a low-temperature environment.

Accordingly, the controller CPU 311 terminates the color misregistration correction processing.

In contrast, if the operation mode of the image forming engine unit 101 notified from the engine control CPU 102 is a mode other than the low-temperature mode (No in S1509), the controller CPU 311 displays the screen 612 on the operation panel 191 in S1511. The screen 612 is a screen for notifying the user that color misregistration correction cannot be performed due to some factor. Accordingly, the controller CPU 311 terminates the color misregistration correction processing. Here, description has been made of a case in which two types of factors that prevent color misregistration correction are notified from the engine control CPU 102; however, three or more types of factors may exist.

Accordingly, in a situation in which a pattern image formed on the intermediate transfer member cannot be sufficiently removed in a low-temperature environment, color misregistration correction is not performed. As a result, it is possible to prevent occurrence of a phenomenon in which a pattern image remaining on the intermediate transfer member is transferred to a sheet and an output image is not properly formed.

### Fourth Embodiment

Hereinafter, an embodiment of the present disclosure in which gradation correction (patch correction) is performed even when the image forming apparatus is in a low-temperature environment will be described with reference to the drawings.

Only differences from the first embodiment will be described below.

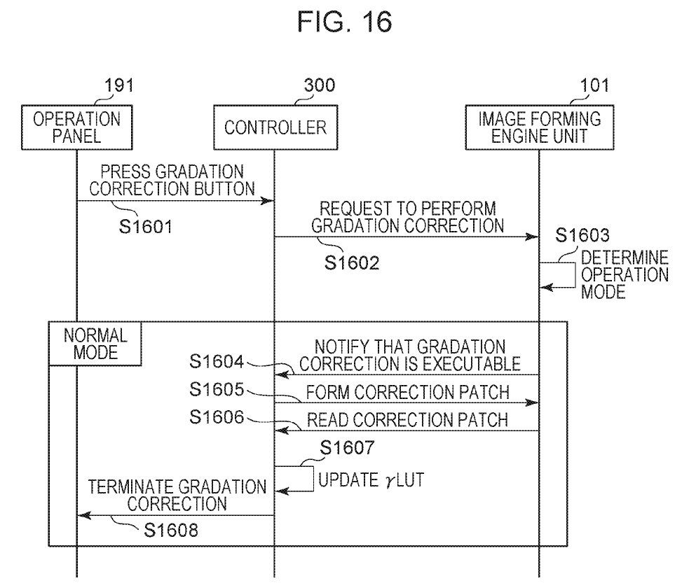

FIG. 16 is a sequence diagram illustrating a series of processes for normal patch correction according to the present embodiment.

In patch correction, main communication is performed among the operation panel 191, the controller 300, and the image forming engine unit 101.

First, when a user presses, in S1601, a gradation correction (patch correction) button on the operation panel 191, the controller 300 starts patch correction processing. In S1602, the controller CPU 311 requests the engine control CPU 102 of the image forming engine unit 101, via the engine I/F unit 316, to perform gradation correction (patch correction).

In S1603, the engine control CPU 102 determines an operation mode of the image forming engine unit 101. An operation mode of the image forming engine unit 101 is determined based on information such as the temperature and humidity of the image forming engine unit 101 obtained from the sensors 350 and the environment sensor 370 of the image forming engine unit 101. Specifically, an operation mode is determined based on a threshold stored in the ROM 103 of the image forming engine unit 101. When the detected temperature is less than or equal to the threshold, the operation mode is set to a low-temperature mode; otherwise, the operation mode is set to a normal mode.

If the operation mode of the image forming engine unit 101 is the normal mode, in S1604, the engine control CPU 102 notifies the controller CPU 311, via the engine I/F unit 316, that gradation correction (patch correction) can be performed. In response to this notification, in S1605, the controller CPU 311 generates a specific pattern image to be used for correction, transfers the specific pattern image to the image forming engine unit 101 via the engine I/F unit 316, and causes a toner image to be formed on the intermediate transfer member 252. In S1606, the engine control CPU 102 reads the density of the toner image with the density sensor 230 and notifies the controller CPU 311 of the density value. Next, in S1607, the controller CPU 311 obtains a target for patch-based gradation correction based on the received density data and the current γLUT stored in the HDD 302 or the RAM 307, and updates the γLUT using the gradation correction table generation unit 306. The updated γLUT is stored in the HDD 302 or the RAM 307. During normal printing on a sheet, the controller CPU 311 transfers, to the image forming engine unit 101, an image subjected to gradation correction by the gradation correction unit 314 with reference to the γLUT stored in the HDD 302 or the RAM 307. Upon completion of updating the γLUT, in S1608, the controller CPU 311 notifies the operation panel 191 that gradation correction (patch correction) has been completed.

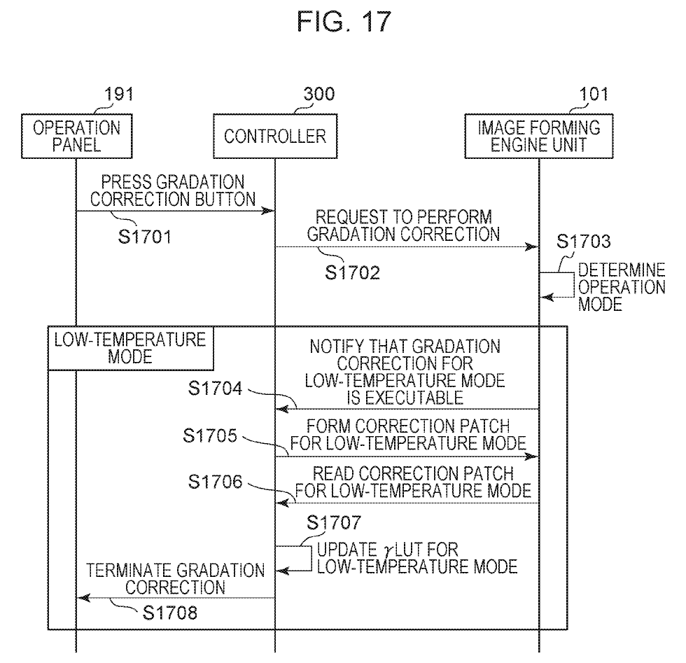

FIG. 17 is a sequence diagram illustrating a series of processes for patch correction performed when the image forming apparatus is in a low-temperature environment according to the present embodiment.

First, when a user presses, in S1701, a gradation correction (patch correction) button on the operation panel 191, the controller 300 starts patch correction processing. In S1702, the controller CPU 311 requests the engine control CPU 102 of the image forming engine unit 101, via the engine I/F unit 316, to perform gradation correction (patch correction).

In S1703, the engine control CPU 102 determines an operation mode of the image forming engine unit 101. An operation mode of the image forming engine unit 101 is determined based on information such as the temperature and humidity of the image forming engine unit 101 obtained from the sensors 350 and the environment sensor 370 of the image forming engine unit 101. Specifically, an operation mode is determined based on a threshold stored in the ROM 103 of the image forming engine unit 101. When the detected temperature is less than or equal to the threshold, the operation mode is set to a low-temperature mode; otherwise, the operation mode is set to a normal mode.

A threshold temperature for the low-temperature mode differs depending on characteristics of the image forming engine unit 101. For example, when the temperature detected by the environment sensor 370 is less than or equal to 7° C, the operation mode is set to the low-temperature mode. In an environment in which the image forming engine unit 101 operates in the low-temperature mode, the elasticity of the cleaning blade configured to collect toner remaining on the intermediate transfer member 252 decreases, so that the toner cannot be normally collected. In particular, the patch correction processing differs from normal printing in which only transfer residual toner remaining on the intermediate transfer member 252 is collected. During patch correction, it is necessary to collect the toner of a specific pattern image used for correction formed on the intermediate transfer member 252, and thus more toner is collected than during normal printing. For this reason, in an environment in which the image forming engine unit 101 operates in the low-temperature mode, the toner of a toner image formed on the intermediate transfer member 252 for patch correction cannot be sufficiently collected, and thus toner is likely to remain on the intermediate transfer member 252. The toner remaining on the intermediate transfer member 252 may be transferred onto a sheet in normal printing performed after patch correction, thereby causing a print output to fail to be a normal image. For this reason, if the engine control CPU 102 determines, in S1703, that an operation mode of the image forming engine unit 101 is the low-temperature mode, the engine control CPU 102 notifies the controller CPU 311, in S1704, that only gradation correction (patch correction) for the low-temperature mode can be performed.

In response to this notification, in S1705, the controller CPU 311 generates a specific pattern image to be used for correction for the low-temperature mode, transfers the specific pattern image to the image forming engine unit 101 via the engine I/F unit 316, and causes a toner image to be formed on the intermediate transfer member 252. Here, by setting the toner density of the pattern image for the low-temperature mode lower than that of a pattern image for the normal mode, toner forming a toner image on the intermediate transfer member 252 can be collected even when the elasticity of the cleaning blade is reduced in a low-temperature environment. In S1706, the engine control CPU 102 reads the density of the toner image with the density sensor 230 and notifies the controller CPU 311 of the density value. In S1707, the controller CPU 311 obtains a target for patch-based gradation correction based on the received density data and the current γLUT for the low-temperature mode stored in the HDD 302 or the RAM 307, and updates the γLUT for the low-temperature mode using the gradation correction table generation unit 306. Here, in update processing of the γLUT performed by the gradation correction table generation unit 306, the pattern image for the low-temperature mode has a lower toner density than a pattern image for the normal mode. The update processing is performed in consideration of the fact that the density value of the toner image notified in S1706 is lower than that notified in normal gradation correction (patch correction). The updated γLUT is stored in the HDD 302 or the RAM 307. During normal printing on a sheet, when the image forming engine unit 101 is operating in the low-temperature mode, the controller CPU 311 refers to the γLUT for the low-temperature mode stored in the HDD 302 or the RAM 307. The controller CPU 311 transfers, to the image forming engine unit 101, an image subjected to gradation correction by the gradation correction unit 314. Upon completion of updating the γLUT, the controller CPU 311 notifies the operation panel 191 of termination of gradation correction (patch correction) in S1708.

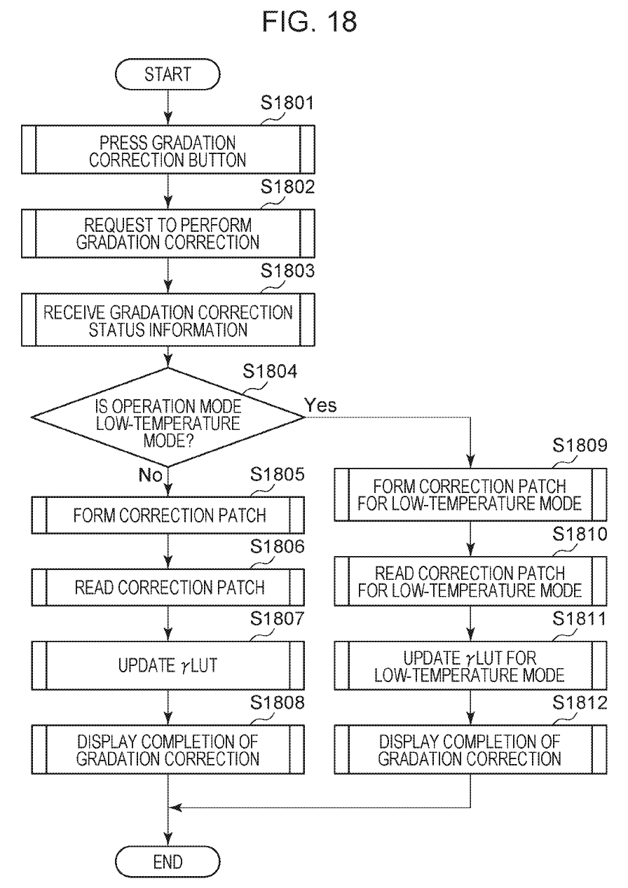

FIG. 18 is a detailed flowchart of patch correction processing according to the present embodiment, for which sequences are shown in FIGS. 16 and 17. Each process of the flowchart of FIG. 18 is implemented by the controller CPU 311 reading a program stored in the HDD 302 into the RAM 307 and executing the program.

In S1801, the controller CPU 311 displays the screens 601 and 605 on the operation panel 191. Upon detecting that the patch correction button 606 has been pressed by the user, the controller CPU 311 requests, in S1802, the engine control CPU 102 via the engine I/F unit 316 to perform gradation correction (patch correction). In response to the request to perform gradation correction (patch correction), the engine control CPU 102 determines an operation mode of the image forming engine unit 101. In S1803, the controller CPU 311 receives status information notified via the engine I/F unit 316 indicating whether gradation correction (patch correction) can be performed.

In S1804, if the controller CPU 311 determines that the received operation mode of the image forming engine unit 101 is the normal mode, and that normal patch correction can be performed (No in S1804), the process proceeds to S1805. In S1805, the controller CPU 311 generates a specific pattern image to be used for correction, transfers the specific pattern image to the image forming engine unit 101 via the engine I/F unit 316, and causes a toner image to be formed on the intermediate transfer member 252. In S1806, the controller CPU 311 receives, via the engine I/F unit 316 from the engine control CPU 102, a value obtained by reading, with the density sensor 230, the toner image formed on the intermediate transfer member 252. In S1807, the controller CPU 311 obtains a target for patch-based gradation correction based on the density data received in S1806 and the current γLUT stored in the HDD 302 or the RAM 307, and updates the γLUT. The controller CPU 311 stores the updated γLUT in the HDD 302 or the RAM 307. Thus, since the patch correction has been completed, in S1808, the controller CPU 311 displays the screen 609 on the operation panel 191, notifies the user of completion of the patch correction, and terminates the patch correction processing.

In contrast, if the controller CPU 311 determines in S1804 that the operation mode of the image forming engine unit 101 is the low-temperature mode and that only patch correction for the low-temperature mode can be performed (Yes in S1804), the process proceeds to S1809. In S1809, the controller CPU 311 generates a specific pattern image to be used for correction in the low-temperature mode, transfers the specific pattern image to the image forming engine unit 101 via the engine I/F unit 316, and causes a toner image to be formed on the intermediate transfer member 252. Here, the pattern image for the low-temperature mode has a lower toner density than a pattern image for the normal mode. In S1810, the controller CPU 311 receives, via the engine I/F unit 316 from the engine control CPU 102, a value obtained by reading, with the density sensor 230, the toner image formed on the intermediate transfer member 252. In S1811, the controller CPU 311 obtains a target for patch-based gradation correction based on the density data received in S1810 and the current γLUT for the low-temperature mode stored in the HDD 302 or the RAM 307, and updates the γLUT for the low-temperature mode. Here, in update processing of the γLUT for the low-temperature mode, a toner image formed on the intermediate transfer member 252 based on the pattern image generated in S1809 has a lower toner density than a pattern image for the normal mode. For this reason, the update processing is performed in consideration of the fact that the density value of the toner image received in S1810 is lower than that for the normal mode. For example, instead of performing update processing using the density data received in S1810 as it is, the update processing is performed after interpolating the density data received in S1810 to density data obtained in patch correction performed in the normal mode.

The controller CPU 311 stores the updated γLUT for the low-temperature mode in the RAM 307. Since the patch correction has been completed in this manner, in S1812, the controller CPU 311 displays the screen 609 on the operation panel 191 to notify the user of completion of the patch correction, and terminates the patch correction processing.

Accordingly, in a situation in which a pattern image formed on the intermediate transfer member cannot be sufficiently removed in a low-temperature environment, the toner density of the pattern image to be formed is set lower than that in the normal mode.

As a result, gradation correction (patch correction) can be performed without the pattern image remaining on the intermediate transfer member.

### Fifth Embodiment

Hereinafter, an embodiment of the present disclosure in which gradation correction (patch correction) is performed in an image forming apparatus without an environment sensor will be described with reference to the drawings.

Only differences from the first embodiment will be described below.

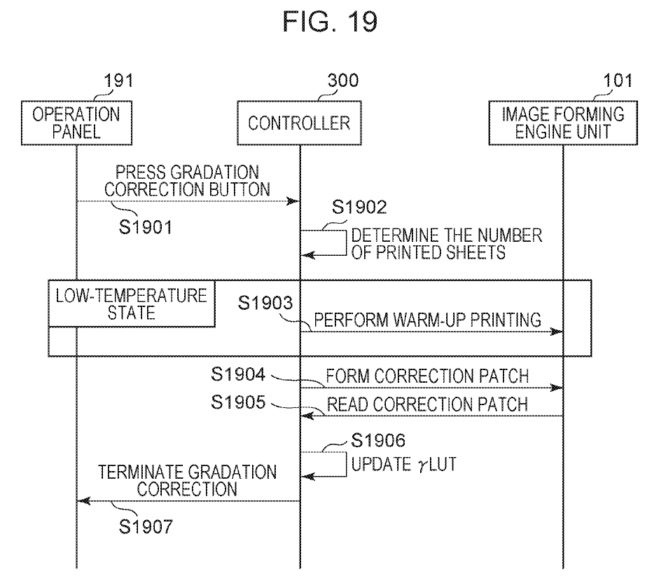

FIG. 19 is a sequence diagram illustrating a series of processes for normal patch correction according to the present embodiment.

In patch correction, main communication is performed among the operation panel 191, the controller 300, and the image forming engine unit 101.

First, when a user presses, in S1901, a gradation correction (patch correction) button on the operation panel 191, the controller 300 starts patch correction processing. The image forming apparatus according to the present embodiment does not include the environment sensor 370 and cannot obtain information on the temperature and humidity of the image forming engine unit 101. Accordingly, in S1902, the controller CPU 311 determines whether the number of sheets output from the image forming apparatus within a predetermined time period until the patch correction processing is started in S1901 exceeds a threshold. If the number of output sheets exceeds the threshold, since the temperature of the image forming engine unit 101 has increased due to the printing operation, the controller CPU 311 determines that the image forming engine unit 101 is not in a low-temperature state. In contrast, if the number of output sheets is less than or equal to the threshold, the controller CPU 311 determines that the image forming engine unit 101 is in a low-temperature state. The threshold for the time period until the patch correction processing is started and the threshold for the number of output sheets are stored in the HDD 302 or the RAM 307 of the controller 300, or in the ROM 103 or the RAM 104 of the image forming engine unit 101. There may be a plurality of combinations of the threshold for the time period until the patch correction processing is started and the threshold for the number of output sheets. Whether the image forming engine unit 101 is not in a low-temperature state may be determined based on all combinations of the thresholds, or based on a single combination of the thresholds. The thresholds may vary depending on the printing speed performance of the image forming engine unit 101.

If the controller CPU 311 determines in S1902 that the image forming engine unit 101 is in a low-temperature state, the controller CPU 311 performs printing in S1903 to increase the temperature of the image forming engine unit 101. Here, printing is performed until the number of sheets reaches or exceeds the threshold stored in the HDD 302 or the RAM 307 of the controller 300, or in the ROM 103 or the RAM 104 of the image forming engine unit 101. A plurality of thresholds for the number of sheets may be provided corresponding to the thresholds used in the determination in S1902 described above.

In S1904, the controller CPU 311 determines, based on the processing up to S1903, that the image forming engine unit 101 is not in a low-temperature state, and generates a specific pattern image to be used for correction. The controller CPU 311 transfers the generated specific pattern image to the image forming engine unit 101 via the engine I/F unit 316, and causes a toner image to be formed on the intermediate transfer member 252. In S1905, the engine control CPU 102 reads the density of the toner image with the density sensor 230 and notifies the controller CPU 311 of the density value. In S1906, the controller CPU 311 obtains a target for patch-based gradation correction based on the received density data and the current γLUT stored in the HDD 302 or the RAM 307, and updates the γLUT using the gradation correction table generation unit 306. The updated γLUT is stored in the HDD 302 or the RAM 307. During normal printing on a sheet, the controller CPU 311 transfers, to the image forming engine unit 101, an image subjected to gradation correction by the gradation correction unit 314 with reference to the γLUT stored in the HDD 302 or the RAM 307. Upon completion of updating the γLUT, the controller CPU 311 notifies the operation panel 191 of termination of gradation correction (patch correction) in S1907.

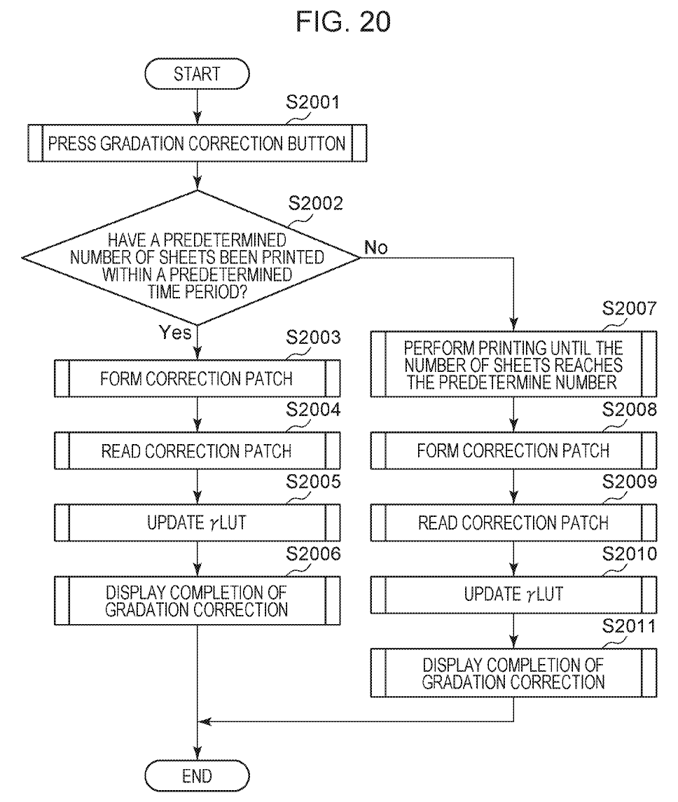

FIG. 20 is a detailed flowchart of patch correction processing according to the present embodiment, for which a sequence is shown in FIG. 19. Each process of the flowchart of FIG. 20 is implemented by the controller CPU 311 reading a program stored in the HDD 302 into the RAM 307 and executing the program.

In S2001, the controller CPU 311 displays the screens 601 and 605 on the operation panel 191, and detects that the patch correction button 606 has been pressed by the user.

In S2002, the controller CPU 311 determines whether printing of a predetermined reference number of sheets has been performed within a predetermined time period until the patch correction button 606 is pressed. For the determination, for example, the threshold stored in the HDD 302 or the RAM 307 of the controller 300, or in the ROM 103 or the RAM 104 of the image forming engine unit 101 is used.

In S2002, if the controller CPU 311 determines that printing of more than a predetermined reference number of sheets has been performed (Yes in S2002), the controller CPU 311 determines that the image forming engine unit 101 is in the normal state. Accordingly, the process proceeds to S2003, where the controller CPU 311 generates a specific pattern image to be used for correction, transfers the specific pattern image to the image forming engine unit 101 via the engine I/F unit 316, and causes a toner image to be formed on the intermediate transfer member 252. In S2004, the controller CPU 311 receives, via the engine I/F unit 316 from the engine control CPU 102, a value obtained by reading, with the density sensor 230, the toner image formed on the intermediate transfer member 252. In S2005, the controller CPU 311 obtains a target for patch-based gradation correction based on the density data received in S2004 and the current γLUT stored in the HDD 302 or the RAM 307, and updates the γLUT. The controller CPU 311 stores the updated γLUT in the HDD 302 or the RAM 307. Thus, since the patch correction has been completed, in S2006, the controller CPU 311 displays the screen 609 on the operation panel 191, notifies the user of completion of the patch correction, and terminates the patch correction processing.

In S2002, if the controller CPU 311 determines that printing of a predetermined reference number of sheets or less has been performed (No in S2002), the controller CPU 311 determines that the image forming engine unit 101 is in a low-temperature state. Accordingly, the process proceeds to S2007, where the controller CPU 311 performs print processing until the number of sheets reaches the threshold. When print processing of a number of sheets that satisfies the threshold has been performed, the controller CPU 311 determines that the image forming engine unit 101 has entered a normal state, and proceeds to S2008. In S2008, the controller CPU 311 generates a specific pattern image to be used for correction, transfers the specific pattern image to the image forming engine unit 101 via the engine I/F unit 316, and causes a toner image to be formed on the intermediate transfer member 252. In S2009, the controller CPU 311 receives, via the engine I/F unit 316 from the engine control CPU 102, a value obtained by reading, with the density sensor 230, the toner image formed on the intermediate transfer member 252. In S2010, the controller CPU 311 obtains a target for patch-based gradation correction based on the density data received in S2009 and the current γLUT stored in the HDD 302 or the RAM 307, and updates the γLUT. The controller CPU 311 stores the updated γLUT in the HDD 302 or the RAM 307.

Thus, since the patch correction has been completed, in S2011, the controller CPU 311 displays the screen 609 on the operation panel 191, notifies the user of completion of the patch correction, and terminates the patch correction processing.

Thus, even in an image forming apparatus without an environment sensor, gradation correction (patch correction) is not performed in a situation in which the image forming apparatus is in a low-temperature state and a pattern image formed on the intermediate transfer member cannot be sufficiently removed. As a result, it is possible to prevent occurrence of a phenomenon in which a pattern image remaining on the intermediate transfer member is transferred to a sheet and an output image is not properly formed.

### Sixth Embodiment

Hereinafter, an embodiment of the present disclosure in which gradation correction (patch correction) is performed in an image forming apparatus without an environment sensor will be described with reference to the drawings.

Only differences from the first embodiment will be described below.

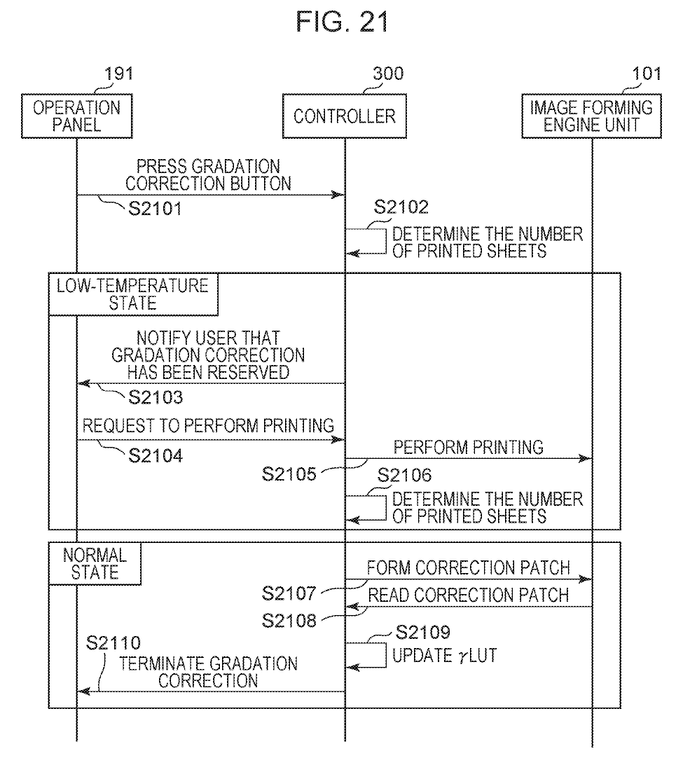

FIG. 21 is a sequence diagram illustrating a series of processes for normal patch correction according to the present embodiment.

In patch correction, main communication is performed among the operation panel 191, the controller 300, and the image forming engine unit 101.

First, when a user presses, in S2101, a gradation correction (patch correction) button on the operation panel 191, the controller 300 starts patch correction processing. The image forming apparatus according to the present embodiment does not include the environment sensor 370 and cannot obtain information such as the temperature and humidity of the image forming engine unit 101. Accordingly, in S2102, the controller CPU 311 determines whether the number of sheets output from the image forming apparatus within a predetermined time period until the patch correction processing is started in S2101 exceeds a threshold. If the number of output sheets exceeds the threshold, since the temperature of the image forming engine unit 101 has increased due to the printing operation, the controller CPU 311 determines that the image forming engine unit 101 is not in a low-temperature state. In contrast, if the number of output sheets is less than or equal to the threshold, the controller CPU 311 determines that the image forming engine unit 101 is in a low-temperature state. The threshold for the time period until the patch correction processing is started and the threshold for the number of output sheets are stored in the HDD 302 or the RAM 307 of the controller 300, or in the ROM 103 or the RAM 104 of the image forming engine unit 101. There may be a plurality of combinations of the threshold for the time period until the patch correction processing is started and the threshold for the number of output sheets. Whether the image forming engine unit 101 is not in a low-temperature state may be determined based on all combinations of the thresholds, or based on a single combination of the thresholds. The thresholds may vary depending on the printing speed performance of the image forming engine unit 101.

In S2102, if the controller CPU 311 determines that the image forming engine unit 101 is in a low-temperature state, the controller CPU 311 determines that patch correction processing cannot be performed. Accordingly, in S2103, the controller CPU 311 does not perform patch correction processing at the time when the gradation correction (patch correction) button is pressed in S2101. At the time when the image forming engine unit 101 enters a normal state in which patch correction processing can be performed, the controller CPU 311 performs correction processing. For this reason, the controller CPU 311 does not perform patch correction processing at present, and notifies the user, by displaying on the operation panel 191, that the patch correction processing has been reserved.

In S2104, when the user requests the image forming apparatus to perform printing, print job information set by the user is transmitted from the operation panel 191 to the controller CPU 311. In S2105, the controller CPU 311 performs normal printing on a sheet using the image forming engine unit 101. Here, the request by the user to cause the image forming apparatus to perform printing in S2104 may be made by a method other than via the operation panel 191. When the controller CPU 311 performs normal printing on a sheet in S2105, the controller CPU 311 determines again in S2106 whether the number of sheets output by the image forming apparatus within a predetermined time period has exceeded the threshold. The determination in S2106 is the same as the determination in S2102. If the number of output sheets has exceeded the threshold due to normal printing performed in S2105, then in S2106, the controller CPU 311 determines that the image forming engine unit 101 is not in a low-temperature state because its temperature has increased due to the printing operation.

In S2107, the controller CPU 311 determines, based on the determination in S2106, that the image forming engine unit 101 is not in a low-temperature state, and generates a specific pattern image to be used for correction. The controller CPU 311 transfers the generated pattern image to the image forming engine unit 101 via the engine I/F unit 316 and causes a toner image to be formed on the intermediate transfer member 252. In S2108, the engine control CPU 102 reads the density of the toner image using the density sensor 230 and transmits the density value to the controller CPU 311. In S2109, the controller CPU 311 obtains a target for patch-based gradation correction based on the received density data and the current γLUT stored in the HDD 302 or the RAM 307, and updates the γLUT using the gradation correction table generation unit 306. The updated γLUT is stored in the HDD 302 or the RAM 307. During normal printing on a sheet, the controller CPU 311 transfers, to the image forming engine unit 101, an image subjected to gradation correction by the gradation correction unit 314 with reference to the γLUT stored in the HDD 302 or the RAM 307. Upon completion of updating the γLUT, the controller CPU 311 notifies the operation panel 191 of completion of the gradation correction (patch correction) in S2110.

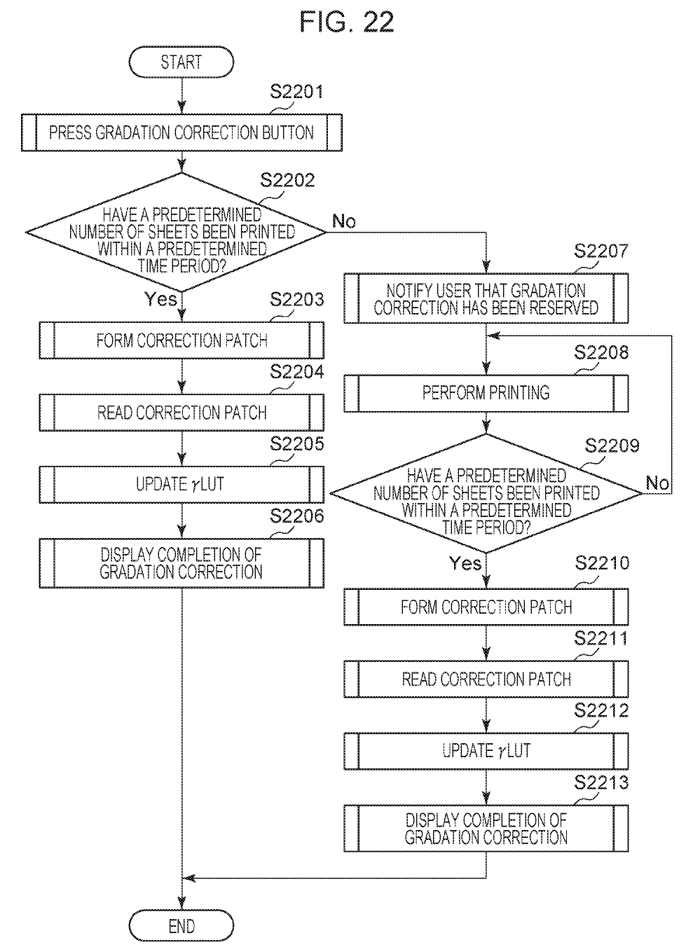

FIG. 22 is a detailed flowchart of patch correction processing according to the present embodiment, for which a sequence is shown in FIG. 21. Each process of the flowchart of FIG. 22 is implemented by the controller CPU 311 reading a program stored in the HDD 302 into the RAM 307 and executing the program.

In S2201, the controller CPU 311 displays the screens 601 and 605 on the operation panel 191, and detects that the patch correction button 606 has been pressed by the user.

In S2202, the controller CPU 311 determines whether printing of a predetermined reference number of sheets has been performed within a predetermined time period until the patch correction button 606 is pressed. For the determination, for example, the threshold stored in the HDD 302 or the RAM 307 of the controller 300, or in the ROM 103 or the RAM 104 of the image forming engine unit 101 is used.

In S2202, if the controller CPU 311 determines that printing of more than the predetermined reference number of sheets has been performed (Yes in S2202), the controller CPU 311 determines that the image forming engine unit 101 is in the normal state. Accordingly, the process proceeds to S2203, where the controller CPU 311 generates a specific pattern image to be used for correction, transfers the specific pattern image to the image forming engine unit 101 via the engine I/F unit 316, and causes a toner image to be formed on the intermediate transfer member 252. In S2204, the controller CPU 311 receives, via the engine I/F unit 316 from the engine control CPU 102, a value obtained by reading, with the density sensor 230, the toner image formed on the intermediate transfer member 252. In S2205, the controller CPU 311 obtains a target for patch-based gradation correction based on the density data received in S2204 and the current γLUT stored in the HDD 302 or the RAM 307, and updates the γLUT. The controller CPU 311 stores the updated γLUT in the HDD 302 or the RAM 307. Thus, since the patch correction has been completed, in S2206, the controller CPU 311 displays the screen 609 on the operation panel 191, notifies the user of completion of the patch correction, and terminates the patch correction processing.

In S2202, if the controller CPU 311 determines that printing of the predetermined reference number of sheets or less has been performed (No in S2202), the controller CPU 311 determines that the image forming engine unit 101 is in a low-temperature state. Accordingly, the process proceeds to S2207, where the controller CPU 311 notifies the user, by displaying on the operation panel 191, that patch correction is not performed at present, and after printing that satisfies the threshold has been performed, patch correction is to be performed. When the controller CPU 311 performs a print job on a sheet in S2208, the controller CPU 311 determines again in S2209 whether printing of the predetermined reference number of sheets has been performed within a predetermined time period. For the determination, for example, the threshold stored in the HDD 302 or the RAM 307 of the controller 300, or in the ROM 103 or the RAM 104 of the image forming engine unit 101 is used.

In S2209, if the controller CPU 311 determines that printing of more than the predetermined reference number of sheets has been performed (Yes in S2209), the controller CPU 311 determines that the image forming engine unit 101 is in a normal state. Accordingly, the process proceeds to S2210, where the controller CPU 311 generates a specific pattern image to be used for correction, transfers the specific pattern image to the image forming engine unit 101 via the engine I/F unit 316, and causes a toner image to be formed on the intermediate transfer member 252. In S2211, the controller CPU 311 receives, via the engine I/F unit 316 from the engine control CPU 102, a value obtained by reading, with the density sensor 230, the toner image formed on the intermediate transfer member 252. In S2212, the controller CPU 311 obtains a target for patch-based gradation correction based on the density data received in S2211 and the current γLUT stored in the HDD 302 or the RAM 307, and updates the γLUT. The controller CPU 311 stores the updated γLUT in the HDD 302 or the RAM 307. Thus, since the patch correction has been completed, in S2213, the controller CPU 311 displays the screen 609 on the operation panel 191, notifies the user of completion of the patch correction, and terminates the patch correction processing.

In contrast, in S2209, if the controller CPU 311 determines that printing of the predetermined reference number of sheets or less has been performed (No in S2209), the controller CPU 311 determines that the image forming engine unit 101 is in a low-temperature state. Accordingly, the process returns to S2208, and the controller CPU 311 repeatedly performs execution of the print job in S2208 and the determination based on the threshold in S2209 until printing that satisfies the threshold has been completed.

Thus, even in an image forming apparatus without an environment sensor, gradation correction (patch correction) is not performed in a situation in which the image forming apparatus is in a low-temperature state and a pattern image formed on the intermediate transfer member cannot be sufficiently removed. As a result, it is possible to prevent occurrence of a phenomenon in which a pattern image remaining on the intermediate transfer member is transferred to a sheet and an output image is not properly formed.

The embodiments of the present disclosure include the following program, method, and configurations.

### Configuration 1

An image forming apparatus comprising:
a transfer unit configured to transfer an image onto a sheet;
a detection unit configured to detect information related to temperature;
a calibration determination unit configured to determine, based on the temperature detected by the detection unit, whether calibration using an image formed by the transfer unit is executable; and
a control unit configured, when the calibration determination unit determines that the calibration is executable, to notify a user that the calibration is to be performed and to control execution of the calibration.

### Configuration 2

The image forming apparatus according to Configuration 1, wherein the calibration determination unit is configured, after a predetermined time after the calibration determination unit determines that the calibration is not executable, to determine again, based on a temperature detected again by the detection unit, whether the calibration is executable.

### Configuration 3

The image forming apparatus according to Configuration 1, further comprising:
a reception unit configured to receive an instruction to perform the calibration,
wherein the calibration determination unit performs the determination based on the instruction being received by the reception unit.

### Configuration 4

The image forming apparatus according to Configuration 1, further comprising:
an update unit configured to update a parameter for the transfer based on a correction value obtained by performing the calibration.

### Configuration 5

An image forming apparatus comprising:
a transfer unit configured to transfer an image onto a sheet;
a detection unit configured to detect information related to temperature;
a density determination unit configured to determine, based on the temperature detected by the detection unit, a density of an image to be formed by the transfer unit; and
a control unit configured to notify a user that calibration is to be performed and to control execution of the calibration using an image formed at the density determined by the density determination unit.

### Configuration 6

The image forming apparatus according to Configuration 5, further comprising:
a reception unit configured to receive an instruction to perform the calibration,
wherein, based on the instruction being received by the reception unit, determination by the density determination unit is performed.

### Configuration 7

The image forming apparatus according to Configuration 5, further comprising:
an update unit configured to update a parameter for the transfer based on a correction value obtained by performing the calibration; and
an interpolation unit configured, when the temperature detected by the detection unit is less than or equal to a predetermined value, to interpolate the correction value for the update with data obtained by performing the calibration using the image formed at the density determined by the density determination unit.

### Configuration 8

An image forming apparatus comprising:
a transfer unit configured to transfer an image onto a sheet;
a calibration determination unit configured to determine, based on the number of sheets printed within a predetermined time period, whether calibration using an image formed by the transfer unit is executable; and
a control unit configured, when the calibration determination unit determines that the calibration is executable, to notify a user that the calibration is to be performed and to control execution of the calibration.

### Configuration 9

The image forming apparatus according to Configuration 8, wherein the calibration determination unit is configured, after a predetermined time after the calibration determination unit determines that the calibration is not executable, to determine again, based on the number of sheets printed within a time period different from the predetermined time period, whether the calibration is executable.

### Configuration 10

The image forming apparatus according to Configuration 8, further comprising:
a reception unit configured to receive an instruction to perform the calibration,
wherein the calibration determination unit performs the determination based on the instruction being received by the reception unit.

### Configuration 11

The image forming apparatus according to Configuration 8, further comprising:
an update unit configured to update a parameter for the transfer based on a correction value obtained by performing the calibration.

### Configuration 12

The image forming apparatus according to Configuration 1, further comprising:
a notification unit configured to notify a user that the calibration is executable.

### Configuration 13

The image forming apparatus according to Configuration 1, further comprising:
a notification unit configured to notify a user of a factor preventing execution of the calibration.

### Configuration 14

The image forming apparatus according to Configuration 1, further comprising:
a correction unit configured to correct, by performing the calibration, a parameter for transfer of at least one of gradation, density, and color tone of an image.

### Configuration 15

The image forming apparatus according to Configuration 1, further comprising:
a reading unit configured to read a printed image using a scanner; and
an execution unit configured to perform the calibration based on the image read by the reading unit.

### Configuration 16

A control method comprising:
transferring an image onto a sheet;
detecting information related to temperature;
determining, based on the temperature detected in the detecting, whether calibration using an image formed in the transferring is executable; and
when it is determined in the determining that the calibration is executable, notifying a user that the calibration is to be performed and controlling execution of the calibration.

### Configuration 17

A control program for causing a computer to function as:
a transfer unit configured to transfer an image onto a sheet;
a detection unit configured to detect information related to temperature;
a calibration determination unit configured to determine, based on the temperature detected by the detection unit, whether calibration using an image formed by the transfer unit is executable; and
a control unit configured, when the calibration determination unit determines that the calibration is executable, to notify a user that the calibration is to be performed and to control execution of the calibration.

In the present disclosure, since color misregistration correction is not performed in a low-temperature environment, the risk that a pattern image remaining on the intermediate transfer member is transferred onto a sheet can be reduced. As a result, it is possible to prevent the occurrence of a phenomenon in which an output image is not properly formed.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-080630, filed May 13, 2025, which is hereby incorporated by reference herein in its entirety.

What is claimed is:

1. An image forming apparatus comprising:
a transfer unit configured to transfer an image onto a sheet;
a detection unit configured to detect information related to temperature;
a calibration determination unit configured to determine, based on the temperature detected by the detection unit, whether calibration using an image formed by the transfer unit is executable; and
a control unit configured, when the calibration determination unit determines that the calibration is executable, to notify a user that the calibration is to be performed and to control execution of the calibration.

2. The image forming apparatus according to claim 1, wherein the calibration determination unit is configured, after a predetermined time after the calibration determination unit determines that the calibration is not executable, to determine again, based on a temperature detected again by the detection unit, whether the calibration is executable.

3. The image forming apparatus according to claim 1, further comprising:
a reception unit configured to receive an instruction to perform the calibration,
wherein the calibration determination unit performs the determination based on the instruction being received by the reception unit.

4. The image forming apparatus according to claim 1, further comprising:
an update unit configured to update a parameter for the transfer based on a correction value obtained by performing the calibration.

5. An image forming apparatus comprising:
a transfer unit configured to transfer an image onto a sheet;
a detection unit configured to detect information related to temperature;
a density determination unit configured to determine, based on the temperature detected by the detection unit, a density of an image to be formed by the transfer unit; and
a control unit configured to notify a user that calibration is to be performed and to control execution of the calibration using an image formed at the density determined by the density determination unit.

6. The image forming apparatus according to claim 5, further comprising:
a reception unit configured to receive an instruction to perform the calibration,
wherein, based on the instruction being received by the reception unit, determination by the density determination unit is performed.

7. The image forming apparatus according to claim 5, further comprising:
an update unit configured to update a parameter for the transfer based on a correction value obtained by performing the calibration; and
an interpolation unit configured, when the temperature detected by the detection unit is less than or equal to a predetermined value, to interpolate the correction value for the update with data obtained by performing the calibration using the image formed at the density determined by the density determination unit.

8. An image forming apparatus comprising:
a transfer unit configured to transfer an image onto a sheet;
a calibration determination unit configured to determine, based on the number of sheets printed within a predetermined time period, whether calibration using an image formed by the transfer unit is executable; and
a control unit configured, when the calibration determination unit determines that the calibration is executable, to notify a user that the calibration is to be performed and to control execution of the calibration.

9. The image forming apparatus according to claim 8, wherein the calibration determination unit is configured, after a predetermined time after the calibration determination unit determines that the calibration is not executable, to determine again, based on the number of sheets printed within a time period different from the predetermined time period, whether the calibration is executable.

10. The image forming apparatus according to claim 8, further comprising:
a reception unit configured to receive an instruction to perform the calibration,
wherein the calibration determination unit performs the determination based on the instruction being received by the reception unit.

11. The image forming apparatus according to claim 8, further comprising:
an update unit configured to update a parameter for the transfer based on a correction value obtained by performing the calibration.

12. The image forming apparatus according to claim 1, further comprising:
a notification unit configured to notify a user that the calibration is executable.

13. The image forming apparatus according to claim 1, further comprising:
a notification unit configured to notify a user of a factor preventing execution of the calibration.

14. The image forming apparatus according to claim 1, further comprising:
a correction unit configured to correct, by performing the calibration, a parameter for transfer of at least one of gradation, density, and color tone of an image.

15. The image forming apparatus according to claim 1, further comprising:
a reading unit configured to read a printed image using a scanner; and
an execution unit configured to perform the calibration based on the image read by the reading unit.

16. A control method comprising:
transferring an image onto a sheet;
detecting information related to temperature;
determining, based on the temperature detected in the detecting, whether calibration using an image formed in the transferring is executable; and
when it is determined in the determining that the calibration is executable, notifying a user that the calibration is to be performed and controlling execution of the calibration.

17. A non-transitory computer readable storage medium having instructions stored thereon that, upon execution of the instructions, causes a computer to function as:
a transfer unit configured to transfer an image onto a sheet;
a detection unit configured to detect information related to temperature;
a calibration determination unit configured to determine, based on the temperature detected by the detection unit, whether calibration using an image formed by the transfer unit is executable; and
a control unit configured, when the calibration determination unit determines that the calibration is executable, to notify a user that the calibration is to be performed and to control execution of the calibration.
